(19) United States
(12) Patent Application Publication
(10) Pub. No.: US 2026/0371341 A1
(43) Pub. Date: Nov. 19, 2026

(54) OVERLAP-BASED CONTINUOUS RATE MATCHING

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US); Wei YANG, San Diego, CA (US); Jing JIANG, San Diego, CA (US)

(21) Appl. No.: 19/209,359

(22) Filed: May 15, 2025

(51) Int. Cl. H04W 72/1263; H04L 1/00; H04W 72/044

(52) U.S. Cl. CPC H04W 72/1263; H04L 1/0003; H04W 72/044

(57) ABSTRACT

Various aspects of the present disclosure generally relate to wireless communication. In some aspects, a user equipment (UE) may receive, from a network node, first control information that schedules an initial transmission of a wireless message that is stored to a first portion of a circular buffer. The UE may receive, from the network node, second control information that schedules a retransmission of the wireless message that is stored to a second portion of the circular buffer, where a starting point of the second portion partially overlaps with an end position of the first portion based on a set of characteristics associated with the retransmission. Numerous other aspects are described.

### FIELD OF THE DISCLOSURE

Aspects of the present disclosure generally relate to wireless communication and specifically relate to techniques, apparatuses, and methods associated with overlap-based continuous rate matching.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, first control information that schedules an initial transmission of a wireless message that is stored to a first portion of a circular buffer. The processing system may be configured to cause the UE to receive, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to a network node. The network node may include a processing system. The processing system may include one or more processors and one or more code-storing memories coupled with the one or more processors. The processing system may be configured to cause the network node to transmit, to a UE, first control information that schedules an initial transmission of a wireless message that is stored to a first portion of a circular buffer. The processing system may be configured to cause the network node to transmit, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to a method of wireless communication performed by a UE. The method may include receiving, from a network node, first control information that schedules an initial transmission of a wireless message that is stored to a first portion of a circular buffer. The method may include receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to a method of wireless communication performed by a network node. The method may include transmitting, to a UE, first control information that schedules an initial transmission of a wireless message that is stored to a first portion of a circular buffer. The method may include transmitting, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to a non-transitory computer-readable medium that stores a set of instructions for wireless communication by a UE. The set of instructions, when executed by one or more processors of the UE, may cause the UE to receive, from a network node, first control information that schedules an initial transmission of a wireless message that is stored to a first portion of a circular buffer. The set of instructions, when executed by one or more processors of the UE, may cause the UE to receive, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to a non-transitory computer-readable medium that stores a set of instructions for wireless communication by a network node. The set of instructions, when executed by one or more processors of the network node, may cause the network node to transmit, to a UE, first control information that schedules an initial transmission of a wireless message that is stored to a first portion of a circular buffer. The set of instructions, when executed by one or more processors of the network node, may cause the network node to transmit, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to an apparatus for wireless communication. The apparatus may include means for receiving, from a network node, first control information that schedules an initial transmission of a wireless message that is stored to a first portion of a circular buffer. The apparatus may include means for receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

Some aspects described herein relate to an apparatus for wireless communication. The apparatus may include means for transmitting, to a UE, first control information that schedules an initial transmission of a wireless message that is stored to a first portion of a circular buffer. The apparatus may include means for transmitting, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following Figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a hybrid automatic repeat request (HARQ) process.

FIG. 3 is a diagram illustrating an example of HARQ redundancy techniques.

FIG. 4 is a diagram illustrating an example of determining a nominal number of coded bits per HARQ transmission and retransmission.

FIG. 5 is a diagram illustrating an example of storing coded bits from HARQ transmissions and retransmissions to a circular buffer according to continuous rate matching and an explicit MCS scheme.

FIG. 6 is a diagram illustrating an example of storing coded bits from HARQ transmissions and retransmissions to a circular buffer according to continuous rate matching and a reserved MCS scheme.

FIG. 7 is a diagram illustrating an example associated with storing coded bits to a circular buffer according to overlap-based continuous rate matching and an explicit MCS scheme.

FIG. 8 is a diagram illustrating an example associated with storing coded bits to a circular buffer according to overlap-based continuous rate matching and a reserved MCS scheme.

FIGS. 9A and 9B are diagrams illustrating examples associated with storing coded bits to a circular buffer according to overlap-based continuous rate matching that combines explicit and reserved MCS schemes.

FIG. 10 is a diagram illustrating an example associated with signaling that enables overlap-based continuous rate matching.

FIG. 11 is a diagram illustrating an example process performed, for example, at a user equipment (UE) or an apparatus of a UE.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

In wireless communication systems, hybrid automatic repeat request (HARQ) processes may be employed to enhance transmission reliability through retransmissions. HARQ processes involve transmitting data, receiving acknowledgments (ACKs) or negative acknowledgments (NACKs), and retransmitting data in cases where a receiving device (e.g., a user equipment (UE) or network node) is unable to receive or decode initial transmissions. For instance, incremental redundancy (IR) HARQ utilizes multiple redundancy versions (RVs) to achieve improved decoding reliability by transmitting different portions of the data during retransmissions. Each RV corresponds to a specific starting point in a circular buffer, enabling distinct portions of data to be transmitted across multiple attempts. This approach enables the receiver device to combine information from multiple transmissions to decode data successfully.

The circular buffer operation in HARQ processes is designed to use systematic and parity bits within the transmitted data. Systematic bits, which are data bits of a wireless message, may be prioritized for protection, while parity bits provide redundancy. However, mapping of systematic bits and parity bits to modulation symbols (particularly in higher-order modulation schemes such as quadrature amplitude modulation (QAM)), introduces challenges. Specifically, the least significant bits (LSBs) in higher-order modulation symbols may be less protected compared to the most significant bits (MSBs), leading to reduced reliability for LSBs. This disparity in protection can impact the end-to-end performance of the communication system, including block error rate (BLER) and throughput.

In HARQ implementations, RV cycling may be used to determine the starting points of retransmissions in the circular buffer. While this approach ensures systematic transmission of different portions of the data, RV cycling may result in repetition of data segments, reducing coding efficiency. Additionally, the rigid structure of RV cycling can lead to gaps or overlaps in the transmitted data, particularly when retransmissions occur across multiple sessions. Such inefficiencies can degrade overall system performance, as redundant transmissions may not sufficiently improve decoding reliability. Therefore, HARQ processes face several technical challenges, including the unequal protection of bits in higher-order modulation schemes, inefficiencies in RV cycling, coding gain limitations, and dependencies on previous grants for a reserved modulation and coding scheme (MCS). These challenges can impact the robustness of HARQ processes against missing retransmission grants and reduce system performance in terms of reliability, coding gain, and data throughput.

Various aspects relate generally to continuous rate matching in circular buffers for HARQ retransmissions in wireless communication systems. Some aspects more specifically relate to a UE receiving, from a network node, first control information that schedules an initial transmission of a wireless message stored to a first portion of a circular buffer, and receiving second control information that schedules a retransmission of the wireless message stored to a second portion of the circular buffer. According to the techniques herein, the starting point of the second portion may partially overlap with an end position of the first portion based on a set of characteristics associated with the retransmission. These characteristics may include a nominal number of coded bits, redundancy version identifiers, circular buffer size, and step-back and step-size parameters.

In some aspects, the step-back parameter may refine the starting point of the retransmission in the circular buffer to ensure that critical bits, such as LSBs from previous transmissions, are retransmitted as MSBs in subsequent transmissions. Such mapping enhances the reliability of higher-order modulation schemes (e.g., QAM) by prioritizing the protection of less robust bits. The step-back parameter may be determined based on modulation order, time domain resource allocation (TDRA), frequency domain resource allocation (FDRA), or other transmission parameters. In some examples, the step-back parameter may be selected from predefined tables or signaled in control information for increased flexibility.

In some aspects, the techniques herein may further address scenarios where control information for retransmissions is missed. For example, the UE may identify missing control information for a scheduled retransmission and skip over the corresponding portion of the circular buffer based on parameters indicated in previous or current control information. This allows the UE to maintain synchronization with the network and ensures that retransmissions are performed efficiently, even in the event of missed scheduling messages.

In some aspects, the techniques herein may include using both an explicit MCS and a reserved MCS for flexible retransmissions. Reserved MCS may provide adaptability in retransmission size and coding rate, allowing the network to optimize redundancy based on channel conditions and feedback, such as a delta channel quality indicator (CQI). For example, an initial set of retransmissions may use reserved MCS for incremental redundancy, while explicit MCS may be used for subsequent retransmissions to ensure complete decoding of the transmitted message.

Particular aspects of the subject matter described in this disclosure can be implemented to realize one or more of the following advantages. By implementing continuous rate matching with overlap-based retransmissions in circular buffers, the described techniques may improve coding gain and reliability for HARQ processes. For example, retransmitting LSBs as MSBs via systematic bit priority mapping (SBPM) reduces the likelihood of transmission errors associated with less protected bits in higher-order modulation schemes. In this way, the techniques may conserve network resources by reducing retransmissions, reducing BLERs, and optimizing throughput efficiency. In some aspects, the described techniques may improve robustness to missed control information events. By enabling the UE to skip over portions of the circular buffer associated with missed grants and continue retransmissions based on current or previous control information, the techniques may maintain synchronization between the UE and the network while reducing the risk of decoding failures and retransmission inefficiencies. In this way, processing resources and memory resources may also be conserved by avoiding redundant decoding attempts and unnecessary signal processing. In some aspects, using reserved MCS for initial retransmissions may provide flexibility to adapt retransmission sizes and coding rates based on channel conditions or feedback, such as delta CQI. This enables the network to optimize redundancy while minimizing signaling overhead. Combining reserved MCS and explicit MCS for retransmissions may ensure efficient use of available resources, such as radio frequency spectrum, while improving decoding reliability. In this way, the described techniques may conserve network bandwidth resources, processing resources, and/or memory resources by balancing adaptability with efficient redundancy allocation. By addressing unequal bit protection in higher-order modulation schemes, inefficiencies in redundancy version cycling, and dependencies on previous grants, the described techniques may enhance the robustness, efficiency, and resource conservation of HARQ processes in wireless communication systems.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

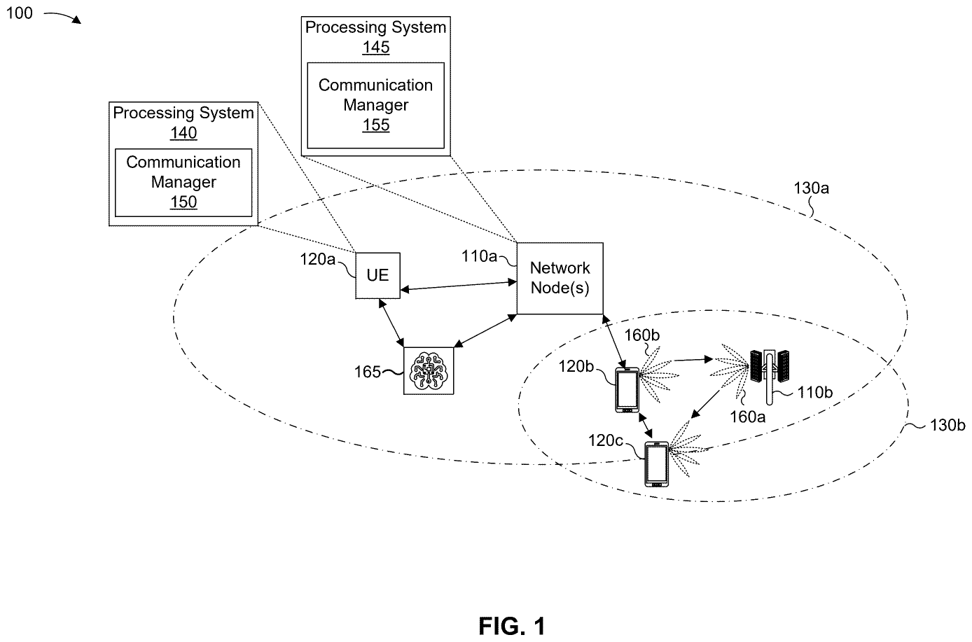

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a MCS or redundancy version parameters. Different DCI formats carry different information, such as scheduling information in the form of downlink or uplink grants, slot format indicators (SFIs), preemption indicators (PIS), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, first control information that schedules an initial transmission of a wireless message that is stored to a first portion of a circular buffer; and receive, from the network node, second control information that schedules a retransmission of the wireless message that is stored to a second portion of the circular buffer, wherein a starting point of the second portion partially overlaps with an end position of the first portion based at least in part on a set of characteristics associated with the retransmission. Additionally, or alternatively, the communication manager 150 may perform one or more other operations described herein.

In some aspects, the network node 110 may include a communication manager 155. As described in more detail elsewhere herein, the communication manager 155 may transmit, to a UE, first control information that schedules an initial transmission of a wireless message that is stored to a first portion of a circular buffer; and transmit, to the UE, second control information that schedules a retransmission of the wireless message that is stored to a second portion of the circular buffer, wherein a starting point of the second portion partially overlaps with an end position of the first portion based at least in part on a set of characteristics associated with the retransmission. Additionally, or alternatively, the communication manager 155 may perform one or more other operations described herein.

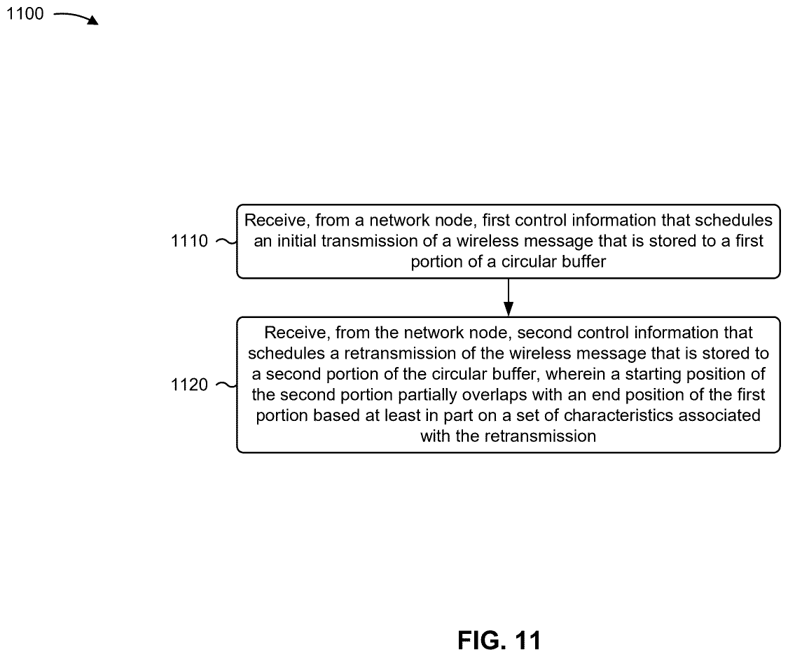

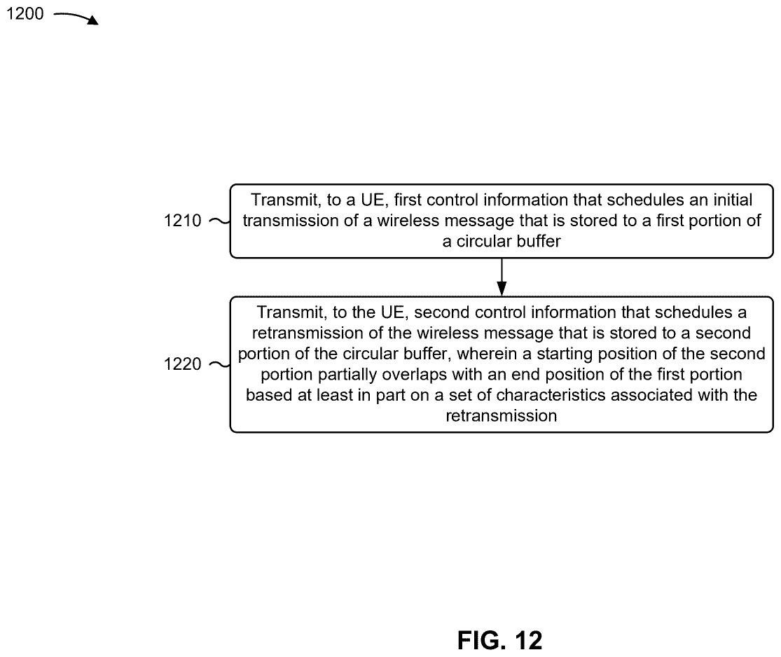

The network node 110, the processing system 145 of the network node 110, the UE 120, the processing system 140 of the UE 120, or any other component(s) of FIG. 1 may implement one or more techniques or perform one or more operations associated with overlap-based continuous rate matching, as described in more detail elsewhere herein. For example, the processing system 145 of the network node 110, or the processing system 140 of the UE 120 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

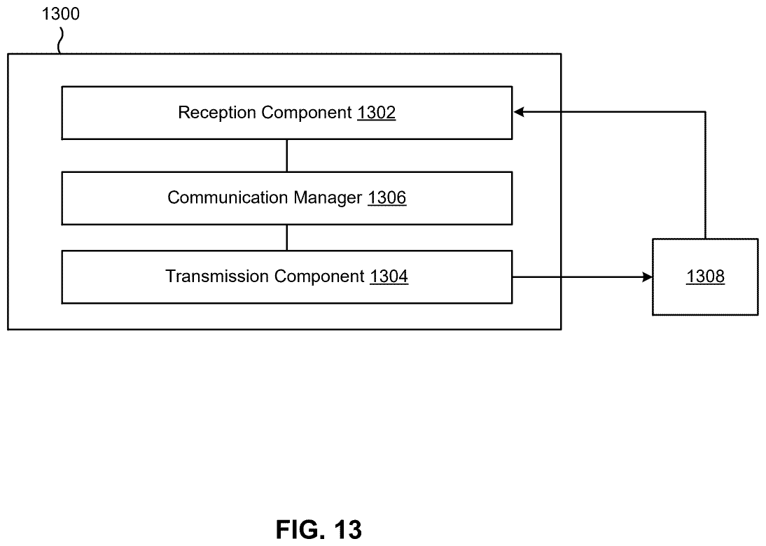

In some aspects, the UE 120 includes means for receiving, from a network node, first control information that schedules an initial transmission of a wireless message that is stored to a first portion of a circular buffer; or means for receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

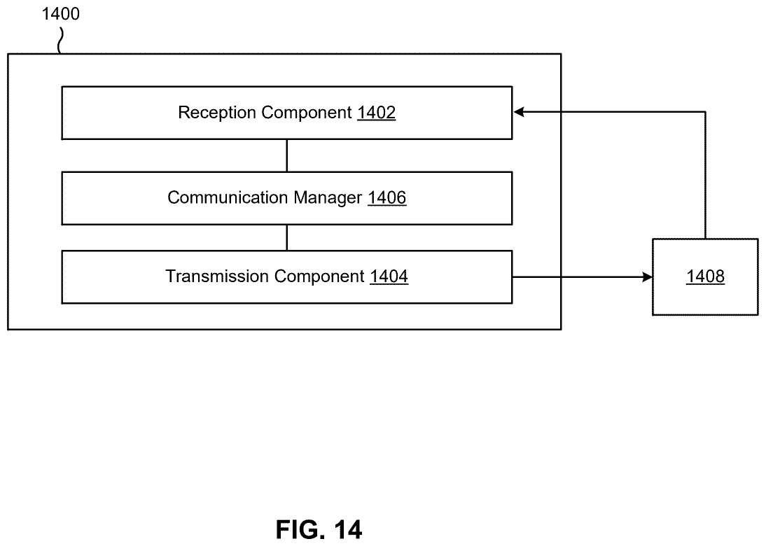

In some aspects, the network node 110 includes means for transmitting, to a UE, first control information that schedules an initial transmission of a wireless message that is stored to a first portion of a circular buffer; or means for transmitting, to the UE, second control information that schedules a retransmission of the wireless message that is stored to a second portion of the circular buffer, wherein a starting point of the second portion partially overlaps with an end position of the first portion based at least in part on a set of characteristics associated with the retransmission. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

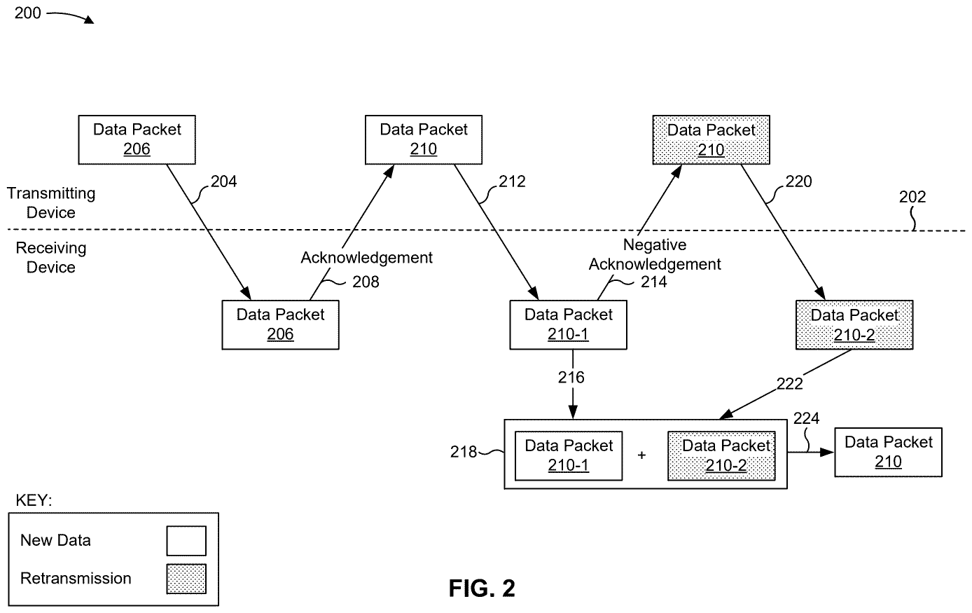

FIG. 2 is a diagram illustrating an example 200 of a HARQ process.

A MAC layer of a protocol stack may implement a HARQ protocol to provide a faster retransmission mechanism relative to other retransmission mechanisms, such as a radio link control (RLC) layer retransmission system. In some examples, the HARQ protocol may include a transmitting device using a retransmission protocol in combination with a receiving device, such as a send and wait (SAW) protocol that enables the receiving device to recover or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), or a first UE 120 and a second UE 120 (e.g., a sidelink HARQ process). Thus, a HARQ process may be used for downlink communications, uplink communications, or sidelink communications. In some examples, and as part of a HARQ process, a network node may transmit information in downlink control information (DCI) that indicates to a receiving device (e.g., a UE 120) which downlink transmission(s) or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

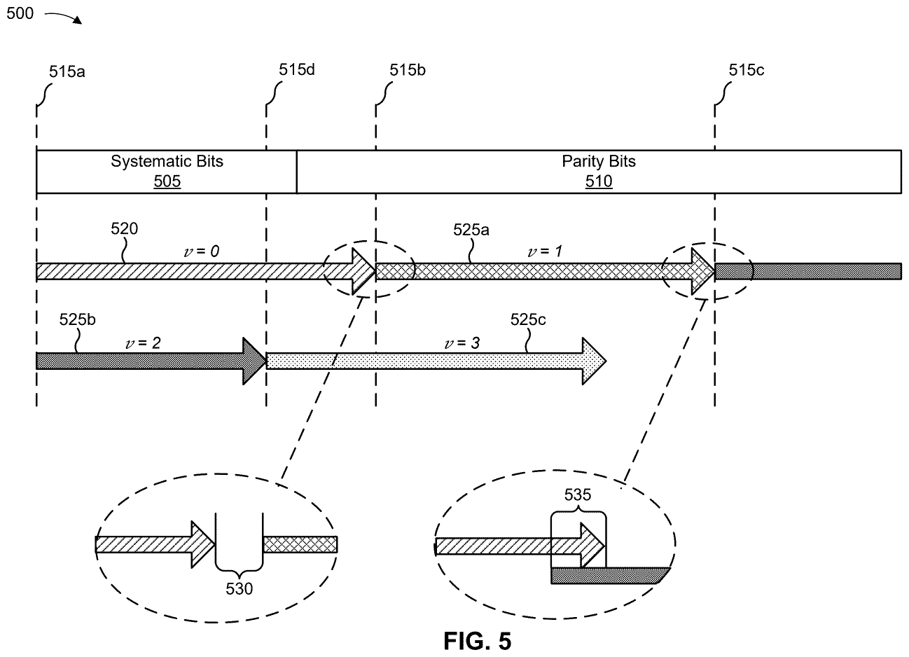

In some examples, a HARQ process or HARQ protocol may enable a receiving device to correct errors in a received data packet, such as by correcting errors within a TB based at least in part on soft combining packets in a physical (PHY) layer as described below. In some examples, a TB may be partitioned into one or more code block groups (CBGs), and each CBG may partitioned into one or more code blocks (CBs) as described with regard to FIG. 5. To correct for errors, the receiving device may buffer one or more data packets that have been identified as including an error, combine the data packets, and process the combined data packets to reduce errors. In some examples, “codeword (CW)” may refer to a TB that includes error protection, and a transmission may include multiple CWs.

In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission). A HARQ feedback codebook transmission may include a feedback message to provide feedback regarding, for example, downlink data transmission (e.g., transmissions associated with a downlink channel), uplink data transmission (e.g., transmissions associated with an uplink channel), or sidelink data transmission (e.g., transmissions associated with a sidelink channel). As used herein, a codebook may be a sequence of bits, which may be constructed using ACK/NACK feedback associated with multiple communications (e.g., multiple downlink communications) that are received during a feedback window. A codebook may include one or more codewords. A codeword may include a message or communication. For example, a codeword may include one or more ACK/NACK feedback indications (e.g., a sequence of one or more HARQ-ACK bit values or HARQ NACK bit values).

The example 200 includes transactions between a transmitting device and a receiving device. Operations or data located above dashed line 202 are performed by, or reside at, a transmitting device (e.g., a network node 110 for a downlink HARQ process, a UE 120 for an uplink HARQ process, or a first UE 120 for a sidelink HARQ process). Operations or data located below the dashed line 202 are performed by, or reside at, a receiving device (e.g., a UE 120 for a downlink HARQ process, a network node 110 for an uplink HARQ process, or a second UE 120 for a sidelink HARQ process). As shown by reference number 204, the transmitting device may transmit a first data packet 206 that is a new transmission of data that is included in the first data packet 206 (e.g., a first transmission of the data, shown through the use of solid white). In some examples, the transmitting device may buffer or store the first data packet 206 as part of a HARQ process until receiving an indication from the receiving device that the first data packet 206 has been received or recovered with minimal errors (e.g., error-free or a number of errors that satisfy a low threshold). Based at least in part on receiving the first data packet 206 with minimal errors, the receiving device may transmit an ACK to the transmitting device as shown by reference number 208, such as a HARQ acknowledgement. The receiving device may validate the first data packet 206 using any suitable error detection mechanism, such as a cyclic redundancy check (CRC) process that validates the received data by computing a CRC value using the received data and comparing the computed CRC value(s) to a CRC value included with the received data.

Based at least in part receiving the ACK, the transmitting device may transmit a second data packet 210 as shown by reference number 212, and the second data packet 210 may be a new transmission of data (e.g., different data than the data included in the first data packet 206). In a similar manner as the first data packet 206, the transmitting device may store the second data packet 210 in the buffer or remove the first data packet 206 from the buffer. In some examples, the receiving device may not receive the second data packet 210 successfully, shown in FIG. 2 as data packet 210-1. For example, the receiving device may identify that the data packet 210-1 was received with a number of errors that do not satisfy the low error threshold. Accordingly, and as shown by reference number 214, the receiving device may transmit a negative acknowledgement (NACK) to indicate that the second data packet 210 was received with errors or unsuccessfully. Alternatively, or additionally, the receiving device may transmit the NACK to indicate a request for a retransmission of the second data packet 210. In some examples, and as shown by reference number 216, the receiving device may store the data packet 210-1 in a buffer 218.

Based at least in part on receiving the NACK, and as shown by reference number 220, the transmitting device may retransmit the second data packet 210 to the receiving device, where the retransmission is shown by FIG. 2 through the use of a dotted pattern. The receiving device may receive the retransmission of the second data packet 210 (shown as data packet 210-2), and, as shown by reference number 222, the receiving device may store the data packet 210-2 in the buffer 218 or may combine the data packet 210 1 with the data packet 210-2. As one example, the receiving device may combine the data packet 210-1 and the data packet 210-2 prior to channel decoding or error detection, and may process the combined data packet to mitigate errors as shown by reference number 224. That is, by processing the combined data packet, the receiving device may recover data that includes minimal errors (e.g., is error-free or includes a number of errors that satisfy the low error threshold). In some examples, the receiving may combine the data packet 210-1 and the data packet 210-2 using soft combining. “Soft combining” may denote combining multiple received signals based at least in part on a confidence or reliability of each received signal, such as by combining received signals using a log likelihood ratio (LLR), to improve a signal quality of the combined data packet and reduce recovery errors.

In some examples, the receiving device may transmit an ACK to the transmitting device, such as in scenarios that the receiving device is able to recover a version of the second data packet 210 that includes minimal errors. In other examples, the receiving device may transmit a NACK to the transmitting device, such as in scenarios that the receiving device is unable to recover a version of the second data packet 210 with minimal errors.

A HARQ process may be used to regulate any combination of PDSCH transmissions, PUSCH transmissions, or physical sidelink shared channel (PSSCH) transmissions. Accordingly, the first data packet 206 or the second data packet 210 shown by FIG. 2 may be based at least in part on one or more PDSCH transmissions, one or more PUSCH transmissions, or one or more PSSCH transmissions. For PDSCH transmissions, the receiving device (e.g., a UE 120) may transmit ACK/NACK feedback via PUCCH or PUSCH. For PUSCH transmission, the receiving device (e.g., a network node 110) may transmit ACK/NACK feedback in an uplink grant (e.g., indicated via downlink control information (DCI)). For a sidelink transmission, the receiving device (e.g., a UE 120) may transmit ACK/ACK feedback via a physical sidelink feedback channel (PSFCH).

As indicated above, FIG. 2 is provided as an example. Other examples may differ from what is described with regard to FIG. 2.

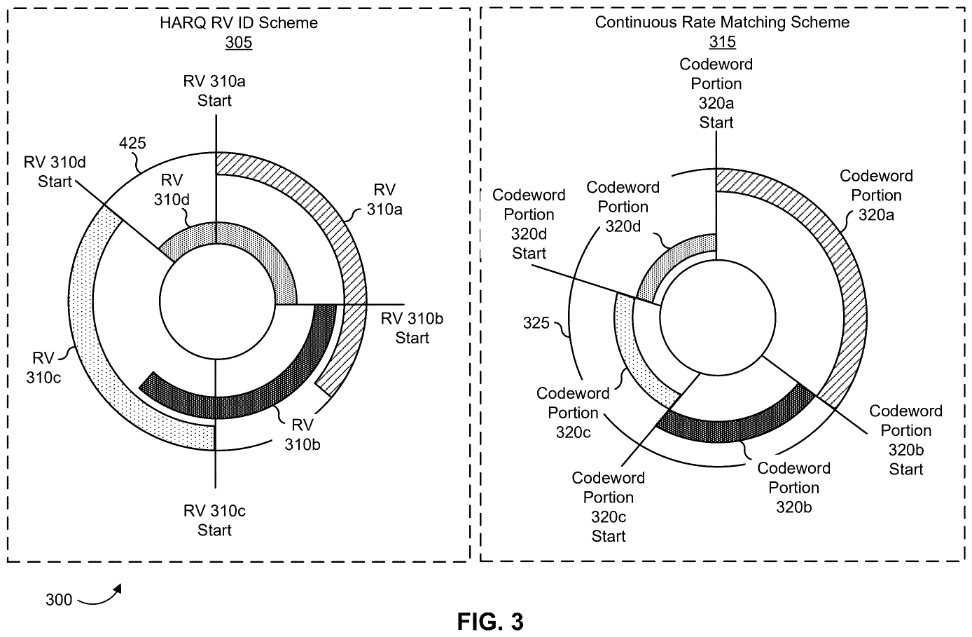

FIG. 3 is a diagram illustrating an example 300 of HARQ redundancy techniques. Example 300 may implement or be implemented by one or more aspects of FIGS. 1 and 2. For instance, example 300 may implement one or more aspects of the HARQ process, as described with reference to FIG. 2. Additionally, the techniques of example 300 may be implemented at a transmitting device and/or a receiving device. In example 300, the receiving device may be described as the UE 120, and the transmitting device may be described as the network node 110; however, the transmitting device and receiving device may be of any of the wireless device types described elsewhere herein.

As shown in FIG. 3, the UE 120 and the network node 110 may be associated with and/or include a circular buffer 325. For example, the UE 120 may use the circular buffer 325 to store transmissions and/or retransmissions of a data packet (such as a TB) in accordance with the HARQ process. Additionally, the network node 110 may encode a TB into a codeword to enable robustness against channel impairments. As described elsewhere herein, a codeword may be the encoded representation of the TB that may include both the original data bits of the TB and redundancy bits added for error detection and correction. For instance, the network node 110 may generate the redundancy bits during the channel coding process and enable the UE 120 to detect and correct errors in the transmitted data. In some examples, one full rotation around the circular buffer 325 may represent storing the entire codeword associated with the TB.

In some examples, the UE 120 may store information associated with a TB in accordance with a HARQ RV ID scheme 305. For instance, to improve the efficiency of HARQ retransmissions, the network node 110 and the UE 120 may operate in accordance with incremental redundancy controlled by RV IDs. In some examples, the RV ID may specify which portion of the codeword may be transmitted in a particular HARQ transmission or retransmission. As shown in FIG. 3, the codeword stored to the circular buffer 325 may be associated with four RVs 310 (e.g., RV 310a, 310b, 310c, and 310d). In some examples, each RV 310 may be an example of or associated with a different RV ID (e.g., RV 310a may be associated with RV0, RV 310b may be associated with RV1, RV 310c may be associated with RV2, and RV 310d may be associated with RV3). In some examples, control information that schedules a HARQ transmission/retransmission associated with a TB may indicate the RV ID. For example, a first DCI that schedules an initial HARQ transmission of the TB may indicate RV0, and a second DCI that schedules a first HARQ retransmission of the TB may indicate RV2.

Additionally, the encoding process associated with the HARQ RV ID scheme 305 may indicate how the UE 120 may store different portions of the codeword associated with different RV IDs to the circular buffer 325. For instance, as shown in FIG. 3, each RV ID may be associated with a different starting point in the circular buffer 325. Therefore, the UE 120 may use the RV ID associated with each HARQ transmission or retransmission of the TB to determine where to begin storing the received portion of the codeword. In some examples, network node 110 may transmit, and the UE 120 may receive, control signaling that indicates the starting point associated with each RV ID. For instance, such control signaling may include one or more of system information signaling (e.g., including master information block (MIB) and/or SIB transmissions), RRC signaling, MAC signaling (e.g., one or more MAC-CEs), or DCI signaling. In some examples, the starting point associated with each RV ID may be preconfigured at the UE 120 (e.g., as part of an original equipment manufacturer (OEM) configuration) and/or associated with a wireless communications standard (e.g., 3GPP).

Additionally, each RV ID may be associated with varying combinations of data bits and redundancy bits of the codeword, which may enable subsequent retransmissions to provide complementary information to the UE 120. For instance, in one example, with reference to FIG. 2, the data packet 210-1 may be associated with RV0, such that the information included in the data packet 210-1 may include a first portion of a codeword associated with RV 310a. Therefore, the UE 120 may begin storing the first portion of the codeword to the circular buffer 325 at the starting point associated with RV 310a. In some examples, the initial HARQ transmission (RV0) may contain a portion of the codeword with more data bits and fewer redundancy bits. Therefore, HARQ retransmissions (e.g., associated with RV1, RV2, and RV3) may be enabled to include different combinations of redundancy bits and data bits. For instance, in the example with reference to FIG. 2, the data packet 210-2 may be associated with RV2, such that the information included in the data packet 210-2 may include a second portion of the codeword associated with RV 310c. Therefore, the UE 120 may begin storing the second portion of the codeword to the circular buffer 325 at the starting point associated with RV 310c. As shown in FIG. 3, RV 310c may not overlap with RV 310a, such that RV 310c may include the second portion of the codeword that is different from the first portion of the codeword associated with RV 310a. In some examples, the RV 310c may include fewer data bits and more redundancy bits compared to the RV 310a, such that RV 310c may provide the UE 120 with an increased number of redundancy bits to increase the probability of decoding the TB.

In some examples, one or more RV IDs may be associated with portions of the codeword that overlap with other portions of the codeword associated with other RV IDs. For instance, as shown in FIG. 3, the RV 310b (e.g., RV1) may be associated with a third portion of the codeword that at least partially overlaps with the first portion of the codeword associated with RV 310a and the second portion of the code word associated with RV 310c. Additionally, the RV 310d (e.g., RV3) may be associated with a fourth portion of the codeword that at least partially overlaps with the first portion of the codeword associated with RV 310a. By receiving different portions of the codeword that at least partially overlap, the HARQ RV ID scheme 305 may enable further redundancy, such that if the initial HARQ transmission of RV0 is received at the UE 120 with one or more errors (such as bit errors), the UE 120 may use the HARQ retransmissions of RV1 and/or RV3 to identify the one or more errors.

In some examples, at the UE 120, the received portions of the codeword from the HARQ transmission and one or more HARQ retransmissions may be soft-combined. As described elsewhere herein, soft-combining is a process where the UE 120 aggregates the reliability metrics (e.g., likelihood or confidence levels) for each received bit from multiple transmissions. By combining these bits, the UE 120 may generate a more complete and robust representation of the original codeword, which may enable the UE 120 to decode the TB successfully.

Therefore, the flexibility provided by the HARQ RV ID scheme 305 may increase the likelihood of successful decoding with fewer retransmissions. Additionally, by systematically providing different portions of the codeword, the HARQ RV ID scheme 305 may reduce redundant retransmissions, which may increase the efficiency of wireless resources.

In some examples, to perform soft-combining and/or other aspects of the HARQ process, the UE 120 may determine a TB size (TBS). For example, the TBS may be a number of original data bits included in the TB. In some examples, the UE 120 may determine the TBS for a TB based on resource allocation information and a code rate indicated in a DCI that schedules the initial HARQ transmission for the TB. For example, the resource allocation information indicated by the DCI may indicate a FDRA (e.g., that specifies the frequency domain resources, such as subcarrier or resource blocks, assigned to the UE 120 for the initial HARQ transmission), indicate a TDRA (e.g., that specifies the time domain resources, such as slots or symbols, assigned to the UE 120 for the initial HARQ transmission), and/or indicate a number of layers (e.g., that specifies the number of spatial layers/streams used for the initial HARQ transmission). In some examples, determination of the TBS may exclude the DMRS resource elements associated with the initial HARQ transmission. Additionally, the DCI may include an MCS field that indicates the code rate. For example, the MCS field may be a set of bits that points to an index of an MCS index table (e.g., configured at the UE 120 and/or associated with a wireless communications standard, such as 3GPP). A given index may indicate a modulation order and the code rate which indicates the MCS for the initial HARQ transmission. The modulation order may refer to a number of distinct symbols that can be transmitted per unit time for an associated wireless transmission, which corresponds to the number of bits represented by each symbol (e.g., orders of 2, 3, and 6 may be respectively associated with modulation schemes such as binary phase shift keying (BPSK), quadrature phase shift keying (QPSK), and 64-QAM). The code rate may indicate the ratio of data information bits over the total number of data information bits and redundancy bits in the transmission. For example, a HARQ transmission with a code rate of 0.50 may include 50% data information bits and 50% redundancy bits. Therefore, the UE 120 may use the resource allocation information and the code rate indicated by the DCI to determine the TBS for a TB.

In some examples of HARQ retransmissions, the network node 110 may indicate, in the scheduling DCI, a reserved MCS. The reserved MCS may indicate the modulation order for the HARQ retransmission and may not indicate the code rate. Therefore, the network node 110 may indicate a reserved MCS for HARQ retransmissions, where the UE 120 has previously determined the TBS of the TB from the initial HARQ transmission. Accordingly, the UE 120 may use the previously determined TBS to correctly store the bits of the HARQ retransmission to the circular buffer 325 (for example, and use the LLRs associated with the bits stored to the circular buffer 325 for subsequent soft-combining). In some examples, the network node 110 may indicate a reserved MCS for HARQ retransmissions to increase flexibility of resource allocation for the retransmissions. For example, because the UE 120 has already determined the TBS, the network node 110 may use a different TDRA, a different FDRA, a different MCS, and/or a different number of layers for the HARQ retransmission, compared to the initial HARQ transmission. Such changes in the resource allocation information and/or the MCS may enable the network node 110 to adapt HARQ retransmissions of a TB to increase probability of successful decoding of the TB at the UE 120.

In some examples, increasing the number of RV IDs associated with the HARQ RV ID scheme 305 may increase the coding gain associated with the incremental redundancy for HARQ. For example, increasing the number of RV IDs may increase coding diversity. For example, each RV ID may correspond to a specific portion of the codeword from the encoding process, which may be stored in the circular buffer 325. Therefore, by increasing the number of RV IDs, more unique subsets of the codeword may be transmitted over multiple HARQ transmissions, which may provide the UE 120 with additional, complementary information, enhancing the diversity of redundancy available for decoding. Additionally, or alternatively, increasing the number of RV IDs may improve error correction capabilities. For example, when the number of RV IDs is higher, the UE 120 may gain access to a broader set of encoded bits, which improves the likelihood of reconstructing the original data of the codeword correctly. Additionally, or alternatively, increasing the number of RV IDs may enhance incremental redundancy. For example, increasing the RV IDs enables a more gradual accumulation of redundancy, allowing the HARQ process to better adapt to challenging channel conditions, such as channel conditions associated with a signal-to-noise ratio (SNR) below an SNR threshold. Additionally, or alternatively, increasing the number of RV IDs may increase coding gain. For example, “coding gain” may refer to an improvement in error correction capability due to the additional redundancy and diversity provided by the coding process. Therefore, by using more RV IDs, the effective redundancy may be spread across multiple transmissions, improving the overall reliability of decoding.

In some cases, however, increasing the number of configured RV IDs may increase signal overhead for scheduling HARQ transmissions and retransmissions. For example, the scheduling DCI may indicate the RV ID for a HARQ transmission/retransmission via an RV ID field, where four RV IDs may be indicated if the bit-width of the RV ID field is two (e.g., ‘00’ indicates RV0, ‘01’ indicates RV1, ‘10’ indicates RV2, and ‘11’ indicates RV3). However, increasing the number of RV IDs above four may increase the bit-width of the RV ID field, which may increase signaling overhead.

In some examples, the UE 120 and network node 110 may operate in accordance with a continuous rate matching scheme 315 to achieve the benefits of increasing the number of configured RV IDs. In accordance with the continuous rate matching scheme 315, a portion of the codeword indicated in a first HARQ retransmission may be directly after a portion of the codeword indicated in the initial HARQ transmission of a TB. For instance, as shown in FIG. 3, an initial HARQ transmission may indicate a codeword portion 320a which the UE 120 may store to the circular buffer 325 starting at the beginning of the circular buffer 325. If the initial HARQ transmission results in a NACK, then the network node 110 may transmit a first HARQ retransmission that may indicate a codeword portion 320b which the UE 120 may store to the circular buffer 325 directly after the codeword portion 320a. In some examples, as shown in FIG. 3, if the UE 120 is unable to decode the TB after storing codeword portions 320a and 320b, then the network node 110 may further transmit a second HARQ retransmission that may indicate a codeword portion 320c, which the UE 120 may store to the circular buffer 325 directly after the codeword portion 320b. In some examples, as shown in FIG. 3, if the UE 120 is unable to decode the TB after storing codeword portions 320a through 320c, then the network node 110 may further transmit a third HARQ retransmission that may indicate a codeword portion 320d, which the UE 120 may store to the circular buffer 325 directly after the codeword portion 320c. Therefore, the continuous rate matching scheme 315 may enable the UE 120 to receive portions of the codeword in order rather than receiving RV IDs to indicate where in the circular buffer 325 to store a codeword portion 320. In some examples, the continuous rate matching scheme 315 may partition the codeword into any number of codeword portions 320, where each codeword portion 320 may include a respective number of bits included in the original codeword. In some examples of the continuous rate matching scheme 315, a given codeword portion 320 may loop back around the circular buffer 325 such that at least a part of the given codeword portion 320 includes bits from one or more previous HARQ transmissions/transmissions.

As indicated above, FIG. 3 is provided as an example. Other examples may differ from what is described with regard to FIG. 3.

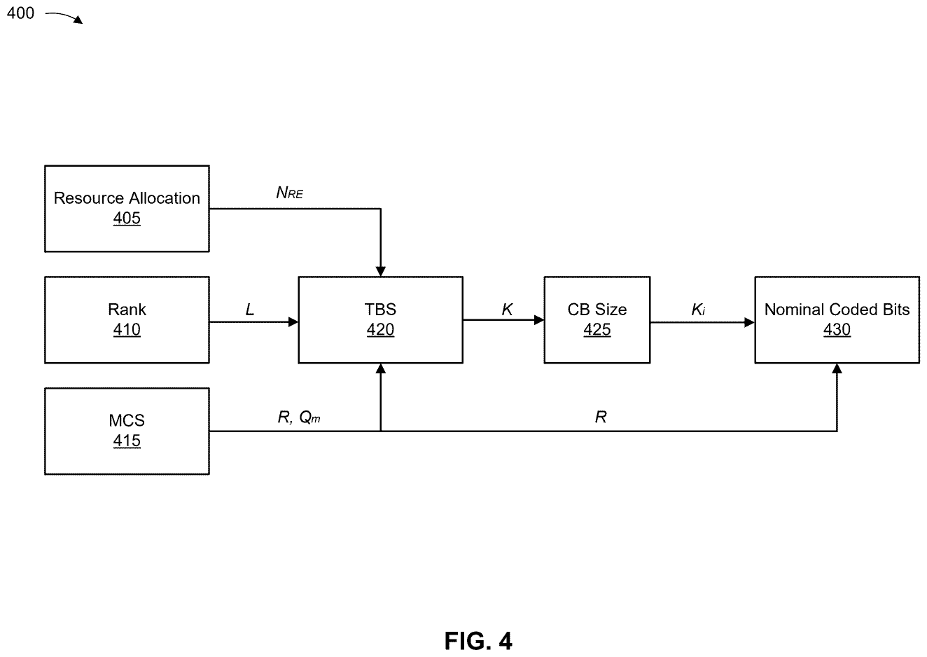

FIG. 4 is a diagram illustrating an example 400 of determining a nominal number of coded bits per HARQ transmission and retransmission. Example 400 may implement or be implemented by one or more aspects of wireless communication network 100, example 200, and example 300. For instance, example 400 may implement one or more aspects of the HARQ process of example 200 and the continuous rate matching scheme 315. Additionally, the techniques of example 300 may be implemented at one or more of the transmitting device or the receiving device described herein (e.g., at one or more of the UE 120 or the network node 110).

As described herein, continuous rate matching may enhance the robustness of data transmissions against the potential loss of DCI events. In scenarios where a granting DCI is missed during any transmission or retransmission (e.g., the receiving device is unable to receive the scheduling DCI), the starting point in the circular buffer to store a transmission or retransmission can be lost, leading to inefficiencies and errors in data handling. To mitigate this risk, the starting point of an RVID may be independent of the reception of other grants related to the same transport block for multiple transmissions/retransmissions. This ensures that each transmission can proceed smoothly without relying on previous DCI receptions, thereby maintaining continuity and reliability. Additionally, for a reserved MCS, the determination of a transport block size (e.g., the TBS 420) inherently relies on the reception of other DCI events, as the reserved MCS does not explicitly indicate the coding rate for retransmissions. This allows for flexibility in handling retransmissions, as the initial transmission's parameters guide subsequent transmissions. To further bolster robustness against missing DCI events, the concept of the “nominal number of coded bits per transmission” can be implemented by the transmitting device and the receiving device. This concept applies to both explicit and implicit (e.g., reserved) MCS scenarios. By establishing a nominal number of coded bits for each transmission, the receiving device and the transmitting device ensure a stable reference point for rate matching, regardless of whether explicit or reserved MCS is used. This approach allows for consistent handling of transmissions and retransmissions, even in the absence of certain DCI events, thereby enhancing the reliability and efficiency of the communication process.

In some examples, the network node 110 may transmit, and the UE 120 may receive, control information (e.g., a scheduling DCI of DCI grant) that schedules transmission of a wireless message (e.g., an uplink transport block or a downlink transport block). Accordingly, the control information may include or indicate one or more of a resource allocation 405, a rank 410, or an MCS 415 that are used for transmission and reception of the wireless message.

As shown by FIG. 4, and example 400, the resource allocation 405 may be determined. For example, a resource allocation 405 (N_{RE}) may specify the frequency domain resources (such as subcarriers or resource blocks) and time domain resources (such as slots or symbols) assigned to a device for a transmission (e.g., a TDRA and FDRA allocation). The resource allocation 405 may be used for determining the available resources for data transmission. In some aspects, the resource allocation 405 may include resource mapping, specifying subcarriers, resource blocks, slots, or symbols allocated for transmission to optimize data flow. Resource mapping can help in dynamically adjusting the allocated resources based on real-time network conditions, thereby improving data throughput efficiency. Additionally, or alternatively, the process may include adaptive resource allocation, modifying frequency and time domain resources in response to network conditions to maintain efficient data transmission. Adaptive resource allocation may involve real-time analysis of network traffic and channel conditions to ensure optimal resource utilization.

As further shown in FIG. 4, the rank 410 (L) may be determined. The rank 410 may refer to the number of spatial layers or streams used for a transmission. That is, the rank 410 determines the level of multiplexing that can be achieved, influencing the data throughput. In some aspects, the rank 410 may include identifying spatial layers to assess a multiplexing capacity of the wireless transmission, impacting the achievable data throughput. Identifying spatial layers can provide insights into the spatial diversity available for transmission, which can be leveraged to enhance signal reliability and throughput. Additionally, or alternatively, the process may include algorithmic adjustments to rank and MCS to achieve optimal performance based on historical transmission data and predicted network demands. Algorithmic adjustments can utilize machine learning techniques to fine-tune transmission parameters for better performance outcomes.

Additionally, as shown in FIG. 4, the MCS 415 may be determined. The MCS indicates the modulation order (Qₘ) and coding rate (R) used for the transmission. The modulation order may refer to the number of distinct symbols that can be transmitted per unit time, and the coding rate may refer to the ratio of data bits to the total number of bits transmitted (including redundancy). In some aspects, the MCS 415 may include determining the modulation scheme, focusing on modulation order, without explicitly mentioning the coding rate, to adjust the transmission symbol capacity (e.g., reserved MCS). This can allow for a more flexible adjustment of modulation parameters based on real-time transmission requirements and channel conditions.

Furthermore, as shown in FIG. 4, a TBS 420 (K) may be calculated. The TBS 420 represents the number of original data bits included in a transport block. The TBS 420 may be determined based on the resource allocation 405 (N_{RE}), rank 410 (L), and MCS 415 (R and Qₘ). For example, K≈N_{RE}×L×Qₘ×R. In some aspects, the TBS 420 may include estimating the transport block capacity, referring to the potential data payload size based on allocated resources and transmission parameters. Estimating transport block capacity provides a predictive measure of the data payload size, which can be adjusted dynamically to accommodate varying transmission demands.

Following this, as depicted in FIG. 4, the CB size 425 may be established. The CB size 425 refers to the size of code blocks into which the transport block is segmented. Code blocks are used for error detection and correction. In some aspects, to determine the CB size 425 the UE 120 may utilize a segmentation strategy for the transport block, focusing on dividing data into manageable units for error control. The segmentation strategy can be adjusted based on the error resilience requirements of the wireless transmission, ensuring robust error control. In some examples, the transport block may be segmented into N CBs (e.g., CB₁ through CB_{N}), where the sum of the code block sizes is equal to the TBS 420 (e.g., K₁+ . . . . Kᵢ . . . +K_{N}=K) and the size of a given CBᵢ is equal to Kᵢ.

Additionally, as shown in FIG. 4, nominal coded bits 430 (Nₙₒₘ) may be determined. The nominal coded bits 430 may represent the number of bits used for a transmission, considering both data bits and redundancy bits. This ensures robustness against transmission errors. In some aspects, to determine the nominal coded bits 430 may include the UE 120 evaluating the total coded bit count, emphasizing the balance between data bits and redundancy to ensure error resilience. Evaluating the total coded bit count can provide insights into the optimal balance needed to maintain error robustness while maximizing data throughput. Additionally, or alternatively, the process may involve adjusting the coding scheme dynamically based on real-time transmission conditions to enhance robustness against errors. Dynamic adjustments to the coding scheme can optimize error control mechanisms, adapting to varying channel conditions for improved reliability. Additionally, or alternatively, an alternative method may involve dynamic rate matching, adjusting the transmission rate to current channel conditions for improved reliability. Dynamic rate matching can ensure that the transmission rate is always suited to the prevailing channel conditions, minimizing error rates and enhancing overall transmission performance.

Accordingly, the nominal coded bits 430 (Nₙₒₘ) serves as a reference point for determining the starting point on the circular buffer for rate matching purposes. In scenarios involving different transmissions with explicit MCS, the network node 110 and the UE 120 ensure that the TBS 420 calculated for each transmission or retransmission remains consistent. In some examples, “explicit MCS” refers to a scenario where the MCS 415 is directly indicated in the DCI for each transmission or retransmission. This explicit indication allows the receiving device to determine the modulation order and coding rate based on explicit indication from each DCI, facilitating the calculation of the TBS 420 and enabling rate matching for each transmission event. Conversely, “reserved MCS” relies on an initial downlink grant that specifies the MCS for the initial transmission. Once the initial transmission MCS is known, subsequent retransmissions can use the reserved MCS without indication of the coding rate again, as the receiving device can use the previously determined TBS 420 from the initial transmission to correctly store and process retransmissions. Accordingly reserved MCS allows for greater flexibility in resource allocation for retransmissions, as the network node 110 can adjust other parameters like TDRA or FDRA while maintaining the same TBS 420, thus adapting to changing network conditions without altering the fundamental coding scheme established during the initial transmission. This consistency of the TBS 420 between transmissions and retransmissions may be maintained as long as the MCS 415 does not change. Therefore, the computed nominal coded bits 430 remains unchanged across both initial transmissions and subsequent retransmissions, providing a stable reference for rate matching and ensuring efficient utilization of the circular buffe

As indicated above, FIG. 4 is provided as an example. Other examples may differ from what is described with regard to FIG. 4.

FIG. 5 is a diagram illustrating an example 500 of storing coded bits from HARQ transmissions and retransmissions to a circular buffer according to continuous rate matching and an explicit MCS scheme. Example 500 may implement or be implemented by one or more aspects of wireless communication network 100, example 200, example 300, and example 400. For instance, FIG. 5 illustrates the transmitting device and the receiving device storing coded bits of a wireless message to a circular buffer. Additionally, the techniques of example 500 may be implemented at one or more of the transmitting device or the receiving device described herein (e.g., at one or more of the UE 120 or the network node 110).

As shown by FIG. 5, and example 500, the transmitting device and the receiving device may store HARQ transmissions and retransmissions to a circular buffer according to an explicit MCS scheme. For example, the circular buffer may store systematic bits 505 and parity bits 510 of one or more code blocks, one or more code block groups, or a transport block. The systematic bits 505 represent the original data bits, while the parity bits 510 provide redundancy for error correction. The circular buffer may have various starting points, such as starting points 515a, 515b, 515c, and 515d, which may be associated with different HARQ redundancy versions and are used for rate matching. In some aspects, storing HARQ transmissions and retransmissions may include implementing a dynamic buffer allocation method where the circular buffer size and allocation are adjusted based on real-time network conditions and data requirements. This approach of dynamic buffer allocation allows the wireless communication system to adapt to changes in traffic and optimize buffer usage for varying network loads.

The starting points 515 for storing the coded bits of transmissions and retransmissions may be based on one or more parameters corresponding to each transmission and retransmission. For example, the receiving device and the transmitting device may determine the starting point (Sₚₒₛ) to store the coded bits for a given transmission or retransmission based on the number of nominal coded bits (Nₙₒₘ), the RVID (v), and the circular buffer size (N_{CirBuf}) configured for the wireless message. For example, Sₚₒₛ=Nₙₒₘ×v mod N_{CirBuf}. Because Nₙₒₘ is MCS dependent, the circular buffer operation for determining the starting point is MCS dependent.

With reference to example 500, a first DCI that schedules an initial transmission 520 of the wireless message indicates an RVID value of v=0. Accordingly, the starting point 515a within the circular buffer where the coded bits of the initial transmission 520 are stored is equal to Nₙₒₘ×0 (e.g., zero, or at the start of the circular buffer).

With reference to example 500, a second DCI that schedules a retransmission 525a of the wireless message indicates an RVID value of v=1. Accordingly, the starting point 515b within the circular buffer where the coded bits of the retransmission 525a are stored is equal to Nₙₒₘ×1 (e.g., directly after the end of the coded bits of initial transmission 520).

With reference to example 500, a third DCI that schedules a retransmission 525b of the wireless message indicates an RVID value of v=2. Accordingly, the starting point 515c within the circular buffer where the coded bits of retransmission 525b are stored is equal to Nₙₒₘ×2 (e.g., directly after the end of the coded bits of a retransmission 525a). As shown in FIG. 5, the coded bits of the retransmission 525b begin with a final portion of the parity bits 510 for the codeword corresponding to the wireless message and end with the systematic bits 505 for the codeword corresponding to the wireless message. Accordingly, the coded bits of the retransmission 525b that include the parity bits 510 are stored to the end portion of the circular buffer, and then the systematic bits 505 included in the retransmission 525b are stored to the start of the circular buffer. That is, the coded bits from the retransmission 525b wrap from the end of the circular buffer back to the beginning of the circular buffer.

With reference to example 500, a fourth DCI that schedules a retransmission 525c of the wireless message indicates an RVID value of v=3. Accordingly, the starting point 515d within the circular buffer where the coded bits of the retransmission 525c are stored is equal to Nₙₒₘ×3 mod N_{CirBuf} (e.g., directly after the end of the coded bits of a retransmission 525b).

In some examples, there could be a gap 530 or an overlap 535 between the end of coded bits stored from a first transmission/retransmission and the starting point for storing coded bits from a subsequent transmission/retransmission. For example, as shown in FIG. 5, there is a gap 530 in the circular buffer between the end of coded bits stored from the initial transmission 520 and the starting point 515b for storing the coded bits of the retransmission 525a. Additionally, as shown in FIG. 5, there is an overlap 535 in the circular buffer between the end of coded bits stored from the retransmission 525a and the starting point 515c for storing the coded bits of the retransmission 525b.

The occurrence of gaps 530 or overlaps 535 in the circular buffer can be attributed to the manner in which the nominal number of coded bits is calculated. For instance, the calculation of Nₙₒₘ may be based on the current detected DCI grant, which may be influenced by the MCS and resource allocation parameters. However, the calculation may overlook certain reserved resource elements (REs) or RBs that are specific to a particular DCI grant. These reserved RBs might not be consistently present across different DCI grants for transmission/retransmissions of a same wireless message, leading to discrepancies in the allocation of resources. As a result, when the rate matching process begins, the starting point on the circular buffer may vary slightly from the intended allocation, causing gaps 530 or overlaps 535 in the data storage.

As indicated above, FIG. 5 is provided as an example. Other examples may differ from what is described with regard to FIG. 5.

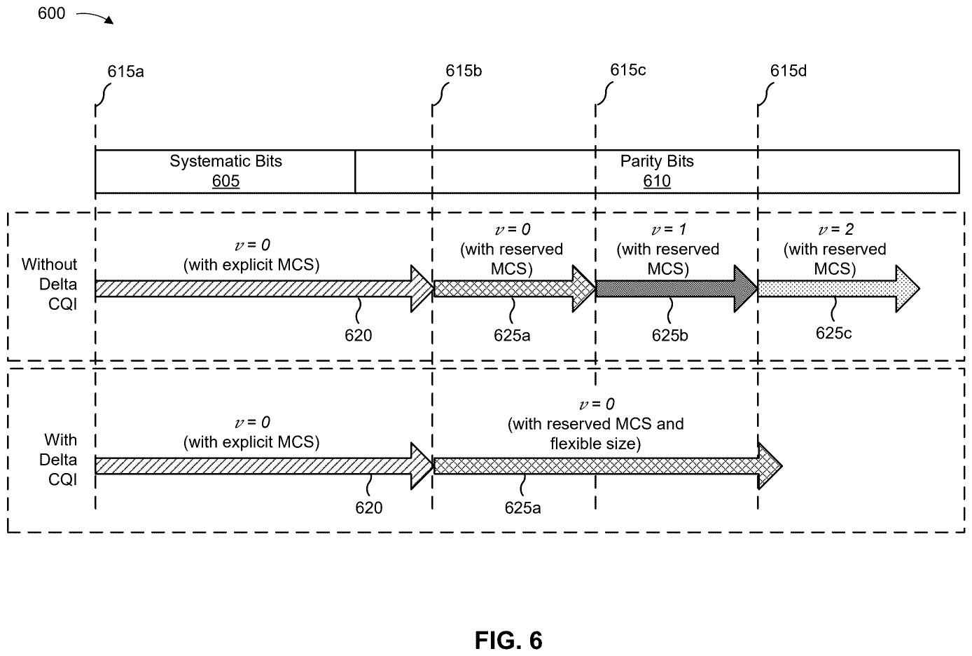

FIG. 6 is a diagram illustrating an example 600 of storing coded bits from HARQ transmissions and retransmissions to a circular buffer according to continuous rate matching and a reserved MCS scheme. Example 600 may implement or be implemented by one or more aspects of wireless communication network 100, example 200, example 300, and example 400. For instance, FIG. 6 illustrates the transmitting device and the receiving device storing coded bits of a wireless message to a circular buffer. In example 600, the receiving device is a UE 120 and the transmitting device is a network node 110. However, in other examples, the receiving device may be the network node 110 and the transmitting device may be the UE 120. Alternatively, the receiving device may a first UE 120 and the transmitting device may be a second UE 120.

As shown by FIG. 6, and example 600, the network node 110 and the UE 120 may store HARQ transmissions and retransmissions of a wireless message to a circular buffer according to a reserved MCS scheme. For example, the UE 120 may store coded bits from an initial transmission 620 and coded bits from one or more retransmissions 625 (e.g., retransmission 625a, 625b, and 625c). The circular buffer may store systematic bits 605 and parity bits 610 of one or more code blocks, one or more code block groups, or a transport block. The systematic bits 605 represent the data bits of the wireless message, while the parity bits 610 provide redundancy for error correction. The circular buffer may have various starting points, such as starting points 615a, 615b, 615c, and 615d, which may be associated with different HARQ redundancy versions and are used for rate matching.

In some examples, the network node 110 may transmit, and the UE 120 may receive, a first DCI that schedules the initial transmission 620 of the wireless message. Additionally, the first DCI may indicate an explicit MCS (e.g., both a modulation order and a code rate), a resource allocation, and an RVID value of v=0. Accordingly, the network node 110 may transmit, and the UE 120 may receive, the initial transmission 620 according to the parameters indicated in the first DCI. Based on the initial transmission 620 being the first transmission attempt for the wireless message, a starting point 615a of where the coded bits of the initial transmission 620 are stored to the circular buffer is equal to zero (e.g., stored from the start of the circular buffer). In example 600, the UE 120 may be unable to successfully decode the wireless message after receiving the initial transmission 620. Accordingly, the UE 120 may transmit, and the network node 110 may receive, a HARQ NACK message indicating unsuccessful decoding of the wireless message.

In some examples, when the UE 120 fails to decode an initial HARQ transmission, the UE 120 can transmit a delta CQI to provide the network node 110 with information about the current channel conditions and to enable the network node 110 to determine a specific number of parity bits 610 (e.g., an amount of redundancy) to retransmit for successful decoding. This delta CQI indicates the change in channel quality relative to a last reported CQI from the UE 120, allowing the network node 110 to adjust a retransmission strategy effectively. By specifying the amount of redundancy, the delta CQI helps ensure that the next retransmission includes enough parity bits 610 for the UE 120 to decode the data successfully. In some examples, the UE 120 may indicate the delta CQI in the feedback message sent by the UE 120, which may be part of the HARQ NACK message reported for the initial transmission 620.

In examples where the UE 120 indicates the delta CQI, the network node 110 may transmit, and the UE 120 may receive, a second DCI that schedules the retransmission 625a. Additionally, the second DCI may indicate a reserved MCS (e.g., indicate a modulation order but not a code rate), a resource allocation, and an RVID value of v=0. Accordingly, the network node 110 may transmit, and the UE 120 may receive, the retransmission 625a. As shown in FIG. 6, based on the UE 120 indicating a delta CQI, the retransmission 625a may have a flexible size (based on adjustments to the FDRA allocation) that accommodates the increased number of parity bits 610 in accordance with the delta CQI. As shown in FIG. 6, the UE 120 may begin to store the coded bits of the retransmission 625a to the circular buffer at starting point 615b. The starting point 615b may be Nₙₒₘ bits after starting point 615a, where Nₙₒₘ is based on the explicit MCS and resource allocation indicated from the first DCI.

In some other examples, however, the UE 120 may not indicate a delta CQI to the network node 110. In such other examples, the network node 110 may transmit, and the UE 120 may receive, one or more retransmissions 625 that include different portions of the parity bits 610 until the UE 120 is able to successfully decode the wireless message. In some examples, the retransmissions 625 may be referred to as “baby-steps” based on incrementing through different portions of the parity bits 610. In examples where the UE 120 does not indicate the delta CQI, the multiple retransmissions may include a fixed number of bits based on a configured step-size (S). For example, the step-size (S) may be a percentage value (e.g., 25%), where the number of bits in each retransmission 625 is equal Nₙₒₘ (determined from the first DCI that indicates the explicit MCS) multiplied by the step-size (S). In some examples, the network node 110 may transmit, and the UE 120 may receive, configuration information that indicates the value of the step-size (e.g., via one or more of system information, RRC signaling, MAC signaling, or DCI signaling). In some examples, the network node 110 may transmit, and the UE 120 may receive, an indication of the step-size in the DCI that schedules the first retransmission 625 (e.g., the DCI that schedules retransmission 625a). In some examples, the UE 120 may select the step-size based on modulation order and the resource allocation (TDRA/FDRA). For example, the UE 120 may be configured (e.g., as part of an original equipment manufacturer (OEM)) with a table that maps different step-sizes to different combinations of modulation orders and resource allocations.

In accordance with determining the value of the step-size (S), the UE 120 may determine the starting point 615 for storing the coded bits of each retransmission 625 to the circular buffer. For example, the UE 120 may determine the starting point (Sₚₒₛ) to store the coded bits for a given retransmission 625 based on the number of nominal coded bits (Nₙₒₘ) calculated for the transmission 620, the RVID (v) for the given retransmission 625, the value of the step-size (S), and the circular buffer size (N_{CirBuf}) configured for the wireless message. For example, the rate matching starting point may be defined as Sₚₒₛ=Nₙₒₘ(1+(S×v)) mod N_{CirBuf}.

With reference to example 600 for cases where the UE 120 does not indicate the delta CQI, a second DCI that schedules a retransmission 625a of the wireless message indicates an RVID value of v=0 and indicates a reserved MCS. Accordingly, the starting point 615b within the circular buffer where the coded bits of the retransmission 625a are stored is equal to Nₙₒₘ×1 (e.g., directly after the end of the coded bits of initial transmission 620).

With reference to example 600 for cases where the UE 120 does not indicate the delta CQI, a third DCI that schedules the retransmission 625b indicates an RVID value of v=1 and indicates a reserved MCS. Accordingly, the starting point 615c within the circular buffer where the coded bits of the retransmission 625b are stored is equal to Nₙₒₘ×(1+S) (e.g., directly after the end of the coded bits of retransmission 625a).

With reference to example 600 for cases where the UE 120 does not indicate the delta CQI, a fourth DCI that schedules the retransmission 625c indicates an RVID value of v=2 and indicates a reserved MCS. Accordingly, the starting point 615d within the circular buffer where the coded bits of the retransmission 625c are stored is equal to Nₙₒₘ×(1+2S) (e.g., directly after the end of the coded bits of retransmission 625b).

This incremental approach of using the step-size helps effectively manage redundancy and error correction, ensuring that the UE 120 has sufficient data to decode the wireless message successfully. Additionally, by not indicating the delta CQI, the UE 120 may reduce signaling overhead, and reduce complexity associated with determining the delta CQI value.

As indicated above, FIG. 6 is provided as an example. Other examples may differ from what is described with regard to FIG. 6.

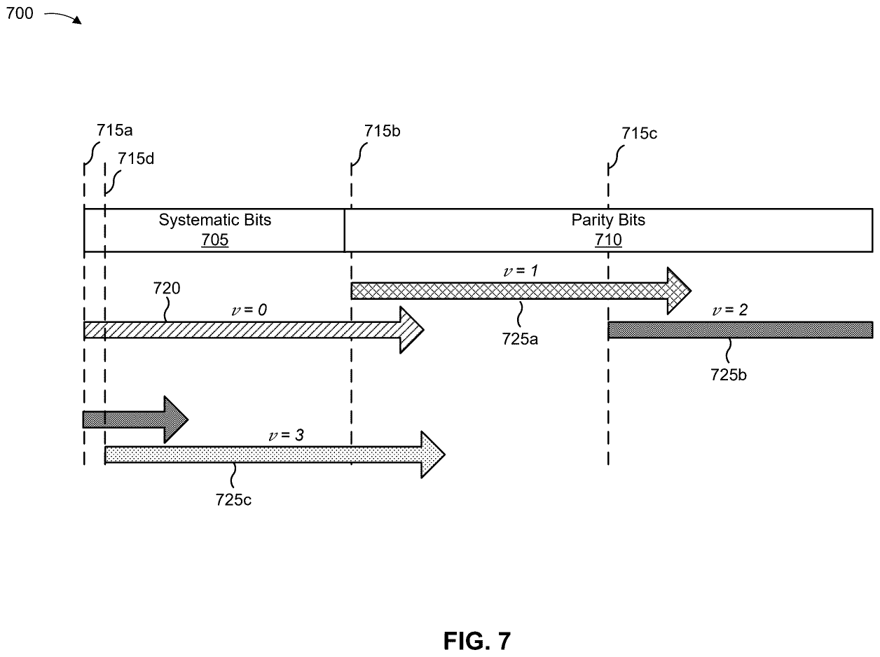

FIG. 7 is a diagram illustrating an example 700 associated with storing coded bits to a circular buffer according to overlap-based continuous rate matching and an explicit MCS scheme. Example 700 may implement or be implemented by one or more aspects of wireless communication network 100, example 200, example 300, example 400, and example 500. For instance, FIG. 7 illustrates the transmitting device and the receiving device storing coded bits of a wireless message to a circular buffer. In example 700, the receiving device is a UE 120 and the transmitting device is a network node 110. However, in other examples, the receiving device may be the network node 110 and the transmitting device may be the UE 120. Alternatively, the receiving device may a first UE 120 and the transmitting device may be a second UE 120.

In higher-order QAM schemes (such as those larger than QPSK), the bits within the modulation symbols do not receive equal levels of protection. This disparity arises because the MSBs may be positioned at the beginning of the transmission, where MSBs are afforded greater protection through coding and error correction mechanisms. In contrast, the LSBs are positioned toward the end of the transmission, where the LSBs are more susceptible to errors due to reduced redundancy and protection. The MSBs are used to maintain the integrity of the transmitted data, as MSBs represent the more significant portion of the information, and thus are prioritized in terms of protection. Conversely, the LSBs are more vulnerable to noise and interference. To address this imbalance, the techniques described herein enable retransmitting the LSBs during retransmissions and repositioning them as MSBs to enhance protection and provide redundancy of the LSBs. That is, retransmissions of a wireless message may include MSBs that overlap with LSBs of the previous transmission. This approach of overlapping may be applicable in both explicit and reserved MCS scenarios, as enabling overlap-based continuous rate matching aims to improve the overall reliability and robustness of the communication by ensuring that all bits of a wireless message, regardless of placement in the wireless message, receive adequate protection against transmission errors.

As shown in FIG. 7, the UE 120 may receive an initial transmission 720 of a wireless message and one or more retransmissions 725 of a wireless message, and store the received coded bits from the multiple transmissions to a circular buffer. The coded bits may include both systematic bits 705 and parity bits 710 as described herein. To determine the starting point 715 to start storing the coded bits for a given transmission/retransmission to the circular buffer, the UE 120 may use one or more parameters indicated in scheduling DCIs. For example, the network node 110 may transmit, and the UE 120 may receive, a first DCI that schedules transmission of the initial transmission 720 for the wireless message. The DCI may indicate a resource allocation (e.g., resource allocation 405), a rank (e.g., 410), and an explicit MCS (e.g., MCS 415), from which the UE 120 may determine the value of Nₙₒₘ for the initial transmission 720 (e.g., the nominal coded bits 430). Additionally, each DCI that schedules the initial transmission 720 or a retransmission 725 may indicate a redundancy value for the HARQ procedure of the wireless message (e.g., an RVID value).

The starting points 715 for storing the coded bits of transmissions and retransmissions may be based on one or more parameters corresponding to each transmission and retransmission. For example, the UE 120 may determine the starting point (Sₚₒₛ) to store the coded bits for a given transmission or retransmission based on the number of nominal coded bits (Nₙₒₘ), the RVID (v), a step-back parameter (β), and the circular buffer size (N_{CirBuf}) configured for the wireless message. For example, Sₚₒₛ may be determined by Sₚₒₛ=Nₙₒₘ×(1−β)×v mod N_{CirBuf}.

With reference to example 700, a first DCI that schedules an initial transmission 720 of the wireless message indicates an explicit MCS and an RVID value of v=0. Accordingly, the starting point 715a within the circular buffer where the coded bits of the initial transmission 720 are stored is equal to Nₙₒₘ×0 (e.g., zero, or at the start of the circular buffer).

With reference to example 700, a second DCI that schedules a retransmission 725a of the wireless message indicates an RVID value of v=1. Accordingly, the starting point 715b within the circular buffer where the coded bits of the retransmission 725a are stored is equal to Nₙₒₘ×(1−β) (e.g., partially overlapping with the end of the coded bits of initial transmission 720 based on the value of β).

With reference to example 700, a third DCI that schedules a retransmission 725b of the wireless message indicates an RVID value of v=2. Accordingly, the starting point 715c within the circular buffer where the coded bits of retransmission 725b are stored is equal to Nₙₒₘ×2(1−β) (e.g., partially overlapping with the end of the coded bits of the retransmission 725a based on the value of β). As shown in FIG. 7, the coded bits of the retransmission 725b begin with a final portion of the parity bits 710 for the codeword corresponding to the wireless message and end with the systematic bits 705 for the codeword corresponding to the wireless message. Accordingly, the coded bits of the retransmission 725b that include the parity bits 710 are stored to the end portion of the circular buffer, and then the systematic bits 705 included in the retransmission 725b are stored to the start of the circular buffer. That is, the coded bits from the retransmission 725b wrap from the end of the circular buffer back to the beginning of the circular buffer.

With reference to example 700, a fourth DCI that schedules a retransmission 725c of the wireless message indicates an RVID value of v=3. Accordingly, the starting point 715d within the circular buffer where the coded bits of the retransmission 725c are stored is equal to Nₙₒₘ×3(1−β) mod N_{CirBuf} (e.g., partially overlapping with the end of the coded bits of the retransmission 725b based on the value of β).

In some examples, the step-back parameter (β) may be based on the modulation order (Q) of the current retransmission. For example, for QPSK, the step-back parameter (β) may be zero (β=0) and for modulation orders larger than QPSK, the step-back parameter (β) may be greater than zero (β=0). For instance, for 256QAM, the step-back parameter (β) may be 0.25. In some examples, the step-back parameter (β) may be the same for all modulation orders that are greater than QPSK. In some examples, the step-back parameter (β) may be different for different modulation orders that are greater than QPSK. In some examples, the step-back parameter (β) may be based on the modulation order (Q) and the resource allocation (e.g., FDRA/TDRA) of the current retransmission. In some examples, the value of the step-back parameter (β) may be hard-coded at the UE 120 (e.g., as part of an OEM configuration) and defined in a wireless communication standard, such as 3GPP. For example, the UE 120 may store, and a wireless communication standard may define, a table that includes a mapping between different combinations of modulation order (Q) and resource allocation (FDRA-TDRA) and a value for the step-back parameter (β). In some examples, the value of the step-back parameter (β) may be signaled in granting DCI that schedules a retransmission 725 along with the explicit MCS.

Accordingly, continuous rate matching that utilizes the step-back parameter (β) can enhance the protection of the least protected bits, specifically the LSBs in higher-order QAM transmissions. By employing continuous rate matching with the step-back parameter (β), these LSBs are retransmitted as MSBs in subsequent transmissions. This strategic repositioning ensures that the LSBs, which were initially less protected, are given priority and enhanced protection, thereby improving the overall end-to-end link performance. Additionally, the network node 110 may encode the initial transmission 720 and the retransmission 725 according to SBPM. For example, SBPM refers to the process of assigning different levels of priority to bits within a coded data block to optimize transmission reliability. In this scheme, systematic bits 705 are given higher priority over parity bits 710 generated during error correction coding. According to SBPM, the LSBs from the previous transmission are mapped as MSBs in the current transmission. This systematic approach ensures that the bits most susceptible to errors are prioritized in retransmissions, thereby increasing the reliability and robustness of the communication link. Through this design, overlap-based continuous rate matching effectively addresses the imbalance in bit protection inherent in higher-order QAM, optimizing the transmission process and enhancing data integrity.

If an explicit MCS is used for the initial transmission 720 and the retransmissions 725, then the overlap-based continuous rate matching may protect against the UE 120 missing a DCI that schedules a retransmission. In one example, the UE 120 may not receive (e.g., may miss) the second DCI that schedules the retransmission 725a. Accordingly, the UE 120 may not receive the retransmission 725a and therefore cannot store the coded bits from the retransmission 725a to the circular buffer. Based on missing the retransmission 725a, the rate-matching may no longer be continuous; however, because the parameters v, Nₙₒₘ, β, and N_{CirBuf} depend on the parameters received on the current grant, the determination of the starting point of the rate-matching in the circular buffer may be independent from receiving previous grants. For instance, even if the UE 120 does not receive retransmission 725a, the UE 120 may receive the third DCI that schedules the retransmission 725c and indicates v, Nₙₒₘ, β, and N_{CirBuf} for the retransmission 725c. Accordingly, the UE 120 may use the parameters indicated by the third DCI to determine the starting point 715c for storing the coded bits of the retransmission 725c to the circular buffer. Therefore, the technique of overlap-based continuous rate matching combined with using explicit MCS for each scheduling DCI increases reliability of decoding the wireless message in cases where a scheduling DCI is missed.

As indicated above, FIG. 7 is provided as an example. Other examples may differ from what is described with regard to FIG. 7.

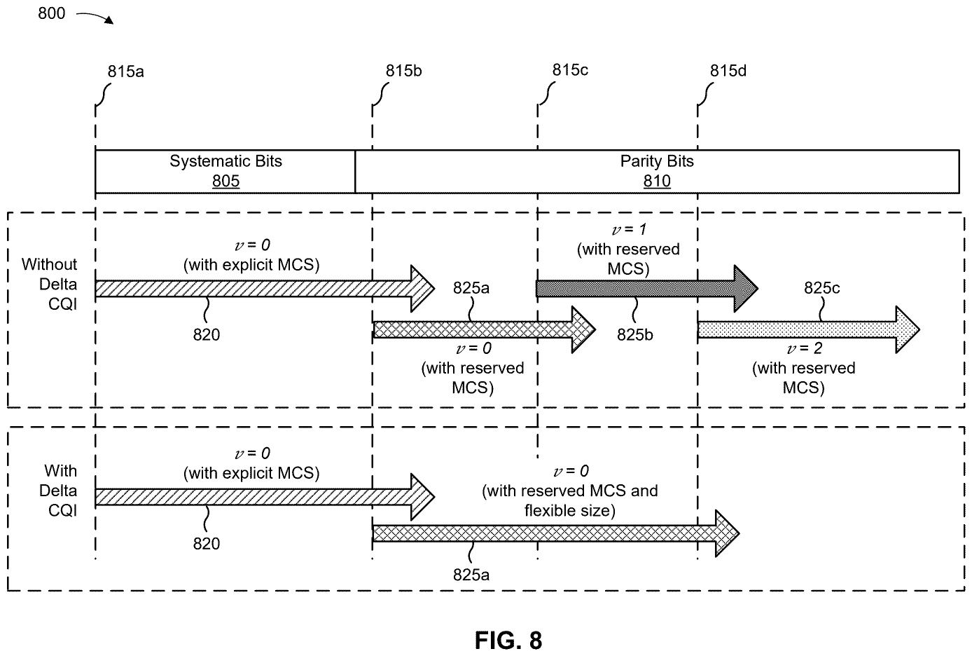

FIG. 8 is a diagram illustrating an example 800 associated with storing coded bits to a circular buffer according to overlap-based continuous rate matching and an reserved MCS scheme. Example 800 may implement or be implemented by one or more aspects of wireless communication network 100, example 200, example 300, example 400, and example 600. For instance, FIG. 8 illustrates the transmitting device and the receiving device storing coded bits of a wireless message to a circular buffer. In example 800, the receiving device is a UE 120 and the transmitting device is a network node 110. However, in other examples, the receiving device may be the network node 110 and the transmitting device may be the UE 120. Alternatively, the receiving device may a first UE 120 and the transmitting device may be a second UE 120.

As shown by FIG. 8, and example 800, the network node 110 and the UE 120 may store HARQ transmissions and retransmissions of a wireless message to a circular buffer according to a reserved MCS scheme. For example, the UE 120 may store coded bits from an initial transmission 820 and coded bits from one or more retransmissions 825 (e.g., retransmission 825a, 825b, and 825c). The circular buffer may store systematic bits 805 and parity bits 810 of one or more code blocks, one or more code block groups, or a transport block. The circular buffer may have various starting points, such as starting points 815a, 815b, 815c, and 815d, which may be associated with different HARQ redundancy versions and are used for rate matching.

In some examples, the network node 110 may transmit, and the UE 120 may receive, a first DCI that schedules the initial transmission 820 of the wireless message. Additionally, the first DCI may indicate an explicit MCS (e.g., both a modulation order and a code rate), a resource allocation, and an RVID value of v=0. Accordingly, the network node 110 may transmit, and the UE 120 may receive, the initial transmission 820 according to the parameters indicated in the first DCI. Based on the initial transmission 820 being the first transmission attempt for the wireless message, a starting point 815a of where the coded bits of the initial transmission 820 are stored to the circular buffer is equal to zero (e.g., stored from the start of the circular buffer). In example 800, the UE 120 may be unable to successfully decode the wireless message after receiving the initial transmission 820. Accordingly, the UE 120 may transmit, and the network node 110 may receive, a HARQ NACK message indicating unsuccessful decoding of the wireless message.

In some examples, when the UE 120 fails to decode an initial HARQ transmission, the UE 120 can transmit a delta CQI to provide the network node 110 with information about the current channel conditions and to enable the network node 110 to determine a specific number of parity bits 810 (e.g., an amount of redundancy) to retransmit for successful decoding. This delta CQI indicates the change in channel quality relative to a last reported CQI from the UE 120, allowing the network node 110 to adjust a retransmission strategy effectively. By specifying the amount of redundancy, the delta CQI helps ensure that the next retransmission includes enough parity bits 810 for the UE 120 to decode the data successfully. In some examples, the UE 120 may indicate the delta CQI in the feedback message sent by the UE 120, which may be part of the HARQ NACK message reported for the initial transmission 820.

In examples where the UE 120 indicates the delta CQI, the network node 110 may transmit, and the UE 120 may receive, a second DCI that schedules the retransmission 825a. Additionally, the second DCI may indicate a reserved MCS (e.g., indicate a modulation order but not a code rate), a resource allocation, and an RVID value of v=0. Accordingly, the network node 110 may transmit, and the UE 120 may receive, the retransmission 825a. As shown in FIG. 8, based on the UE 120 indicating a delta CQI, the retransmission 825a may have a flexible size (based on adjustments to one or more of the FDRA or the TDRA) that accommodates the increased number of parity bits 810 in accordance with the delta CQI. As shown in FIG. 8, the UE 120 may begin to store the coded bits of the retransmission 825a to the circular buffer at starting point 815b. The starting point 815b may be Nₙₒₘ bits after starting point 815a, where Nₙₒₘ is based on the explicit MCS and resource allocation indicated from the first DCI.

In some other examples, however, the UE 120 may not indicate a delta CQI to the network node 110. In such other examples, the network node 110 may transmit, and the UE 120 may receive, one or more retransmissions 825 that include different portions of the parity bits 810 until the UE 120 is able to successfully decode the wireless message. In examples where the UE 120 does not indicate the delta CQI, the multiple retransmissions may include a fixed number of bits based on a configured step-size (S) (e.g., similar to aspects of example 600). For example, the step-size (S) may be a percentage value (e.g., 25%) or decimal value (e.g., 0.25), where the number of bits in each retransmission 825 is equal Nₙₒₘ (determined from the first DCI that indicates the explicit MCS) multiplied by the step-size (S). In addition to the step-size (S), the UE may utilize the step-back parameter (β) as provided herein (e.g., which may be a function of the modulation order and FDRA-TDRA, where the modulation order is indicated by the reserved MCS). Conversely to overlap-based continuous rate matching using explicit MCS, using reserved MCS may enable the retransmissions 825 to be transmitted with a different modulation order, a different resource allocation (FDRA-TDRA), or a combination thereof (e.g., as indicated by the reserved MCS).

In accordance with determining the value of the step-size (S) and the step-back parameter (β), the UE 120 may determine the starting point 815 for storing the coded bits of each retransmission 825 to the circular buffer. For example, the UE 120 may determine the starting point (Sₚₒₛ) to store the coded bits for a given retransmission 825 based on the number of nominal coded bits (Nₙₒₘ) calculated for the transmission 820, the RVID (v) for the given retransmission 825, the value of the step-size (S), and the circular buffer size (N_{CirBuf}) configured for the wireless message. For example, the rate matching starting point may be defined as

$${S}_{pos} = ( {N}_{nom} \times ( 1 - {β}_{0} ) + {\sum }_{i = 1}^{v} {N}_{nom} \times {S}_{i} \times ( 1 - {β}_{i} ) ) mod {N}_{CirBuf} .$$

For example, βᵢ is the value of the step-back parameter for the i-th retransmission 825 with reserved MCS and Sᵢ is the value of the step-size of the i-th retransmission 825 with reserved MCS.

With reference to example 800 for cases where the UE 120 does not indicate the delta CQI, a second DCI that schedules a retransmission 825a of the wireless message indicates an RVID value of v=0, indicates a reserved MCS, and indicates the value of β₀ for the step-back parameter. Accordingly, the starting point 815b within the circular buffer where the coded bits of the retransmission 825a are stored is equal to Nₙₒₘ×(1−β₀) (e.g., overlapping with the end of the coded bits of initial transmission 820 based on the value of β₀).

With reference to example 800 for cases where the UE 120 does not indicate the delta CQI, a third DCI that schedules the retransmission 825b indicates an RVID value of v=1, indicates a reserved MCS, indicates the value of β₁ for the step-back parameter, and indicates a value of S₁ for the step-size. Accordingly, the starting point 815c within the circular buffer where the coded bits of the retransmission 825b are stored is equal to Nₙₒₘ×((1−β₀)+S₁(1−β₁)) (e.g., overlapping with the end of the coded bits of retransmission 825a based on the value of (1).

With reference to example 800 for cases where the UE 120 does not indicate the delta CQI, a fourth DCI that schedules the retransmission 825c indicates an RVID value of v=2, indicates a reserved MCS, indicates the value of β₂ for the step-back parameter, and indicates a value of S₂ for the step-size. Accordingly, the starting point 815c within the circular buffer where the coded bits of the retransmission 825b are stored is equal to Nₙₒₘ×((1−β₀)+S₁(1−β₁)+S₂(1−β₂)) (e.g., overlapping with the end of the coded bits of retransmission 825b based on the value of β₂).

In some examples, the step-back parameter (β) may be based on the modulation order (Q) of the current retransmission. For example, for QPSK, the step-back parameter (β) may be zero (β=0) and for modulation orders larger than QPSK, the step-back parameter (β) may be greater than zero (β=0). For instance, for 256QAM, the step-back parameter (β) may be 0.25. In some examples, the step-back parameter (β) may be the same for all modulation orders that are greater than QPSK. In some examples, the step-back parameter (β) may be different for different modulation orders that are greater than QPSK. In some examples, the step-back parameter (β) may be based on the modulation order (Q) and the resource allocation (e.g., FDRA/TDRA) of the current retransmission. In some examples, the value of the step-back parameter (β) may be hard-coded at the UE 120 (e.g., as part of an OEM configuration) and defined in a wireless communication standard, such as 3GPP. For example, the UE 120 may store, and a wireless communication standard may define, a table that includes a mapping between different combinations of modulation order (Q) and resource allocation (FDRA-TDRA) and a value for the step-back parameter (β). In some examples, the value of the step-back parameter (β) may be signaled in granting DCI that schedules a retransmission 725 along with the reserved MCS.

If the modulation order (Q) of all retransmissions 825 with the reserved MCS are the same, then Sᵢ=S based on Qᵢ=Q∀i. Accordingly, the equation used by the UE 120 to calculate the value of a given starting point 815 simplifies such that Sₚₒₛ=(Nₙₒₘ×(1−β)+Nₙₒₘ×S×v×(1−β) mod N_{CirBuf}, where v is the RVID indicated by granting DCI with reserved MCS for the given retransmission 825 corresponding to the given starting point 815.

If a reserved MCS is used for the initial transmission 820 and the retransmissions 825, then the overlap-based continuous rate matching may protect against the UE 120 missing a DCI that schedules a retransmission 825. In one example, the UE 120 may not receive (e.g., may miss) the third DCI that schedules the retransmission 825b. Accordingly, the UE 120 may not receive the retransmission 825b and therefore cannot store the coded bits from the retransmission 825b to the circular buffer. Based on missing the retransmission 825b, the rate-matching may no longer be continuous; however, the UE 120 can identify that a missing DCI event has occurred since the RVID of the reserved MCS DCI that is missed can be recovered (e.g., because RVID with continuous rate-matching works as a counter). For example, if the UE 120 does not receive the third DCI that indicates an RVID value of v=1 and reserved MCS but does receive the fourth DCI that indicates the RVID value of v=2, the UE 120 can identify that the UE 120 missed the third DCI based on not receiving a DCI that indicates an RVID value of v=1 for the HARQ process. Accordingly, the UE 120 may skip a portion of the circular buffer equal to an amount that corresponds to the allocation of the third DCI with reserved MCS that the UE 120 missed. In some examples, the amount to skip in the circular buffer can be determined based on the step-size and step-back parameter for the current DCI (e.g., the fourth DCI scheduling retransmission 825c) or based on the step-size and step-back parameter for the first DCI grant that indicated explicit MCS. That is, if the UE 120 misses the third DCI that indicates v=1, β₁, and S₁, then for determining the starting point 815d, the UE 120 may set β₁ equal to β₀ or β₂ and may set S₁ equal to S₀ or S₁. In a first example, the UE 120 can skip over starting point 815c and calculate the starting point 815d as Nₙₒₘ×(1−β₀)+Nₙₒₘ×S₀×(1−β₀)+Nₙₒₘ×S₂×(1−β₂) (e.g., S₁=S₀ and β₁=β₀). In a second example, the UE 120 can skip over starting point 815c and calculate the starting point 815d as Nₙₒₘ×(1−β₀)+Nₙₒₘ×S₂×(1−β₂)+Nₙₒₘ×S₂×(1−β₂) (e.g., S₁=S₂ and β₁=β₂).

As described herein, overlap-based continuous rate matching according to reserved MCS offers advantages in enhancing end-to-end link performance, particularly in scenarios where the modulation order of reserved MCS grants is lower than that of explicit MCS grants. Additionally, the use of overlap-based continuous rate matching allows for the retransmission of LSBs from the previous transmission as the MSBs in the current transmission. The implementation of a back-off strategy, combined with SBPM, ensures that these LSBs receive enhanced protection, thereby optimizing the robustness and efficiency of the communication link. Therefore, this overlap in rate matching conserves network resources reduces error rates, leading to improved throughput and reliability in wireless communication systems.

As indicated above, FIG. 8 is provided as an example. Other examples may differ from what is described with regard to FIG. 8.

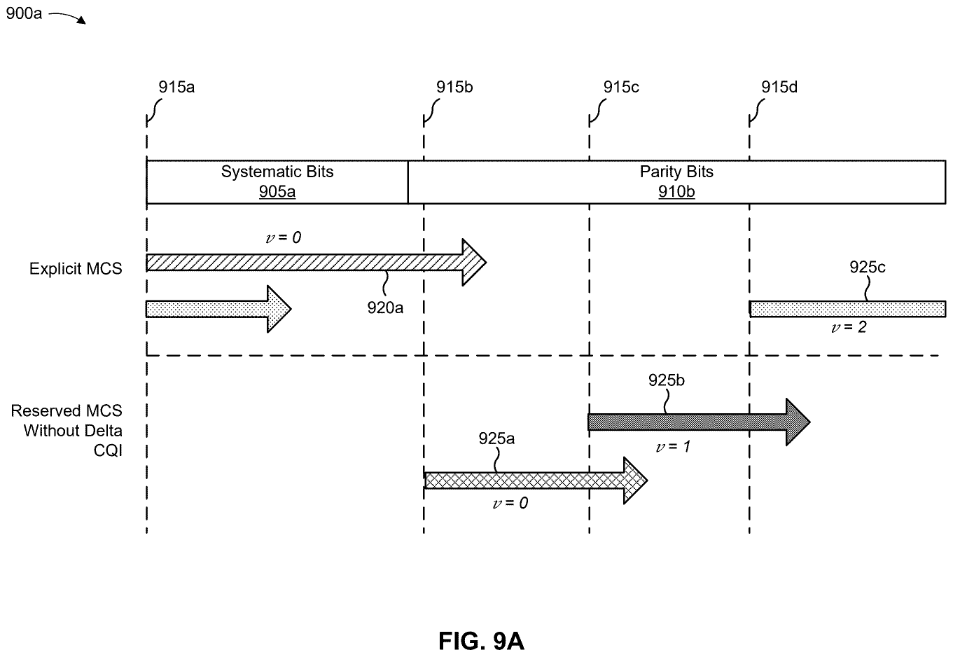

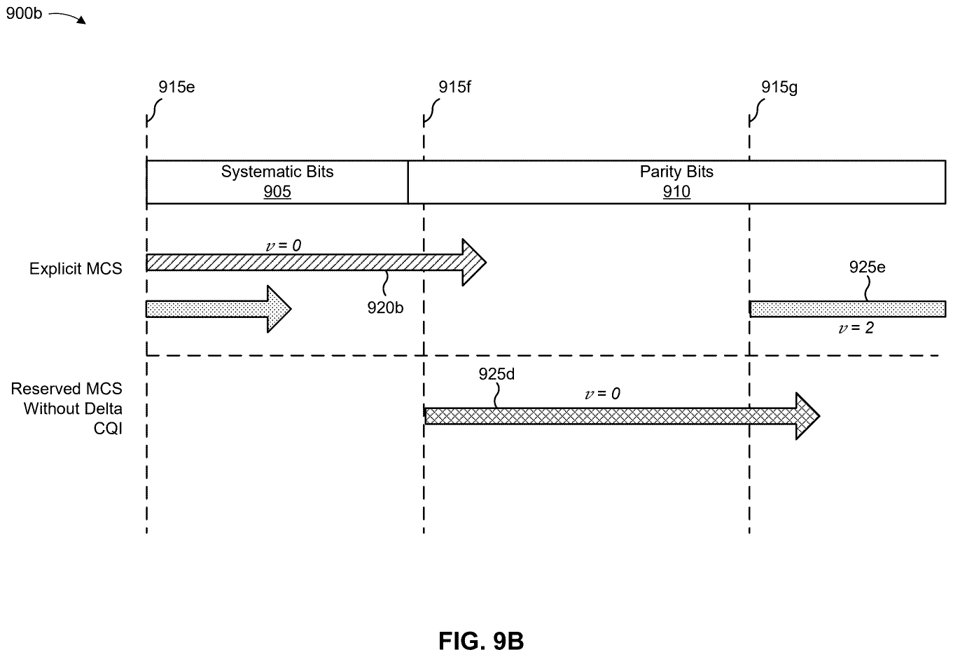

FIGS. 9A and 9B are diagrams illustrating examples 900a and 900b associated with storing coded bits to a circular buffer according to overlap-based continuous rate matching that combines explicit and reserved MCS schemes. Examples 900a and 900b may implement or be implemented by one or more aspects of wireless communication network 100 and examples 200 through 800. For instance, FIGS. 9A and 9B illustrate the transmitting device and the receiving device storing coded bits of a wireless message to a circular buffer. In examples 900a and 900b, the receiving device is a UE 120 and the transmitting device is a network node 110. However, in other examples, the receiving device may be the network node 110 and the transmitting device may be the UE 120. Alternatively, the receiving device may a first UE 120 and the transmitting device may be a second UE 120.

In accordance with examples 900a and 900b, the UE 120 may store coded bits from a received transmission 920 and one or more retransmissions 925 to a circular buffer. The transmission 920 and the one or more retransmissions 925 include various portions of systematic bits 905 and parity bits 910 of a wireless message (e.g., where the wireless message is one or more code blocks, one or more code block groups, or a transport block). As described herein, the examples 900a and 900b provide the UE 120 storing coded bits to the circular buffer according to overlap-based continuous rate matching. Additionally, the examples 900a and 900b describe a HARQ procedure where one or more scheduling DCIs indicate explicit MCS and one or more scheduling DCIs indicate reserved MCS. In other words, the UE 120 may implement one or more aspects from examples 700 and 800 to perform overlap-based continuous rate matching according to both explicit and implicit MCS.

With reference to FIG. 9A, the network node 110 may transmit, and the UE 120 may receive, a first DCI that schedules transmission of an initial transmission 920a of a wireless message. Additionally, the first DCI indicates explicit MCS and an RVID value of v=0 for the initial transmission 920a. A starting point 915a where the UE 120 starts to store the coded bits of the initial transmission 920a to the circular buffer is zero. Based on being unable to decode the wireless message after the initial transmission 920a, the UE 120 may transmit, and the network node 110 110 may receive, a HARQ NACK message for the initial transmission 920a. Additionally, with reference to example 900a, the UE 120 does not indicate a delta CQI value. Accordingly, the network node 110 may transmit, and the UE 120 may receive, a second DCI that indicates reserved MCS and an RVID value of v=0 for a retransmission 925a. A starting point 915b where the UE 120 starts to store the coded bits of the retransmission 925a to the circular buffer may be based on a step-back parameter and step-size parameter indicated for the retransmission 925a. Based on being unable to decode the wireless message after receiving the retransmission 925a, the network node 110 may transmit, and the UE 120 may receive, a third DCI that indicates reserved MCS and an RVID value of v=1 for a retransmission 925b. A starting point 915c where the UE 120 starts to store the coded bits of the retransmission 925b to the circular buffer may be based on a step-back parameter and a step-size parameter indicated for the retransmission 925b. Based on being unable to decode the wireless message after receiving the retransmission 925b, the network node 110 may transmit, and the UE 120 may receive, a fourth DCI that indicates explicit MCS and an RVID value of v=2 for a retransmission 925c. A starting point 915d where the UE 120 starts to store the coded bits of the retransmission 925c to the circular buffer may be based on a step-back parameter and the parameters of the explicit MCS indicated for the retransmission 925c.

If the step-size for example 900a is 25% or 0.25, then the initial transmission 920a includes Nₙₒₘ coded bits based on explicit MCS indicated in the first DCI, the retransmission 925a includes 25% of Nₙₒₘ coded bits based on the reserved MCS and the value of the step-size, the retransmission 925b includes 25% of Nₙₒₘ om coded bits based on the reserved MCS and the value of the step-size, and the retransmission 925c includes Nₙₒₘ coded bits based on explicit MCS indicated in the fourth DCI. By reverting back to explicit MCS for the retransmission 925c, the network node 110 and the UE 120 may reduce delay associated with continuously performing retransmissions using reserved MCS. Accordingly, reverting back to explicit MCS after satisfying a configured number of retransmissions using reserved MCS may enable the network to leverage the resource flexibility, reduction in complexity, and signaling overhead enabled by reserved MCS and leverage the increase in communication reliability provided by explicit MCS.

With reference to FIG. 9B, the network node 110 may transmit, and the UE 120 may receive, a first DCI that schedules transmission of an initial transmission 920b of a wireless message. Additionally, the first DCI indicates explicit MCS and an RVID value of v=0 for the initial transmission 920b. A starting point 915e where the UE 120 starts to store the coded bits of the initial transmission 920b to the circular buffer is zero. Based on being unable to decode the wireless message after the initial transmission 920b, the UE 120 may transmit, and the network node 110 may receive, a HARQ NACK message for the initial transmission 920b. Additionally, with reference to example 900b, the UE 120 may indicate a delta CQI value in the HARQ NACK message. Accordingly, the network node 110 may transmit, and the UE 120 may receive, a second DCI that indicates reserved MCS and an RVID value of v=0 for a retransmission 925d. A starting point 915f where the UE 120 starts to store the coded bits of the retransmission 925d to the circular buffer may be based on a step-back parameter for the retransmission 925d. Based on being unable to decode the wireless message after receiving the retransmission 925d, the network node 110 may transmit, and the UE 120 may receive, a third DCI that indicates explicit MCS and an RVID value of v=2 for a retransmission 925e. A starting point 915g where the UE 120 starts to store the coded bits of the retransmission 925e to the circular buffer may be based on a step-back parameter and the parameters of the explicit MCS indicated for the retransmission 925e.

If the initial transmission 920a includes Nₙₒₘ coded bits based on explicit MCS indicated in the first DCI, then retransmission 925d includes X % of Nₙₒₘ coded bits based on the delta CQI. Additionally, the UE 120 may identify to skip in the circular buffer by (100−X) % of Nₙₒₘ for starting point 915g for storing the Nₙₒₘ coded bits of retransmission 925e, where the Nₙₒₘ coded bits of retransmission 925e are based on the explicit MCS indicated by the third DCI that schedules retransmission 925e. By reverting back to explicit MCS for the retransmission 925d, the network node 110 and the UE 120 may utilize the communication reliability provided by explicit MCS to reduce the number of errors in the coded bits stored to the circular buffer in cases where the indication of the delta CQI was unable to provide a sufficient number of coded bits for the UE 120 to successfully decode the wireless message.

As indicated above, FIGS. 9A and 9B are provided as an example. Other examples may differ from what is described with regard to FIGS. 9A and 9B.

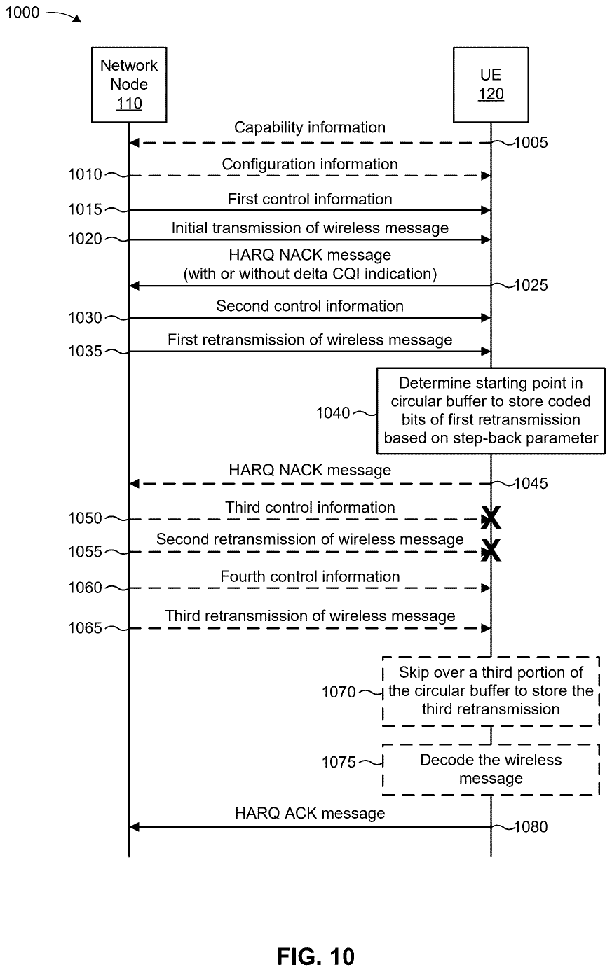

FIG. 10 is a diagram illustrating an example 1000 associated with signaling that enables overlap-based continuous rate matching. Example 1000 may implement or be implemented by one or more aspects of wireless communication network 100, examples 200 through 800, and examples 900a and 900b. For instance, example 1000 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 1000 shows operations between the UE 120 and the network node 110, the communications may occur between any number of network devices of various types described herein. In example 1000, the UE 120 serves as the receiving device to receive an initial transmission and one or more retransmissions of a wireless message (e.g., a downlink wireless message). In some other examples, however, the UE 120 may be the transmitting device, such that the network node 110 may schedule the UE 120 (via the control information described herein) to transmit an initial transmission and one or more retransmissions of a wireless message (e.g., an uplink wireless message). Therefore, one or more operations described as being performed by the UE 120 may additionally or alternatively be performed by the network node 110 and one or more operations described as being performed by the network node 110 may additionally or alternatively be performed by the UE 120.

In a first operation 1005, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in the capability report.

The capability information may indicate whether the UE 120 supports a feature and/or one or more parameters related to the feature. For example, the capability information may indicate a capability that the UE 120 supports overlap-based continuous rate matching. In other words, the capability information may indicate that the UE 120 is capable of operating in accordance with one or more step-back parameters (β) (described herein) to allow partial overlap between the LSBs of a first transmission/retransmission and the MSBs of a subsequent retransmission. One or more operations described herein may be based on the capability information. For example, the UE 120 may perform one or more operations of example 1000 in accordance with the capability information or may receive one or more of configuration information or control information that is in accordance with the capability information. The network node 110 may determine configuration information for the UE 120 based on the capability information.

In a second operation 1010, the network node 110 may transmit, and the UE 120 may receive, the configuration information. In some aspects, the UE 120 may receive the configuration information via one or more of system information signaling (e.g., a master information block MIB and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an OEM configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate one or more step-back parameters to use for overlap-based continuous rate matching. In some examples, the configuration information explicitly indicates the step-back parameter to use. In some examples, the configuration information indicates that the step-back parameter is based on a modulation order associated with the retransmission, a TDRA associated with the retransmission, and an FDRA associated with the retransmission. In some examples, the configuration information indicates for the UE 120 to select the step-back parameter from a table (e.g., stored by the UE 120 as part of an OEM configuration) that includes a set of step-back parameters respectively associated with a set of modulation order and resource allocation combinations. That is the, UE 120 can select a given step-back parameter to use for a given retransmission based on the modulation order and resource allocation indicated in the control information that schedules the given retransmission. In some examples, the configuration information indicates that a step-back parameter may be indicated per control information (e.g., scheduling DCI) that schedules a retransmission of the wireless message.

In some examples, the configuration information may indicate one or more step-size parameters (S) (described herein) to use for overlap-based continuous rate matching in cases of reserved MCS. In some examples, the configuration information explicitly indicates the step-size parameter to use. In some examples, the configuration information indicates that the step-size parameter is based on a modulation order associated with the retransmission, a TDRA associated with the retransmission, and an FDRA associated with the retransmission. In some examples, the configuration information indicates for the UE 120 to select the step-size parameter from a table (e.g., stored by the UE 120 as part of an OEM configuration) that includes a set of step-size parameters respectively associated with a set of modulation order and resource allocation combinations. That is the, UE 120 can select a given step-size parameter to use for a given retransmission based on the modulation order and resource allocation indicated in the control information that schedules the given retransmission. In some examples, the configuration information indicates that a step-size parameter may be indicated per control information (e.g., scheduling DCI) that schedules a retransmission of the wireless message.

In a third operation 1015, the network node 110 may transmit, and the UE 120 may receive, first control information (first scheduling DCI) that schedules an initial transmission of a wireless message that is stored to a first portion of a circular buffer. For example, the starting point of the first portion in the circular buffer is at a start of the circular buffer based on the first portion being associated with the initial transmission.

In a fourth operation 1020, the network node 110 may transmit, and the UE 120 may receive, the initial transmission of the wireless message according to one or more parameters indicated in the first control information (e.g., one or more of resource allocation 405, rank 410, or MCS 415).

In a fifth operation 1025, the UE 120 may transmit, and the network node 110 may receive, a HARQ NACK message indicating unsuccessful decoding of the initial transmission. In some examples, the HARQ NACK message may include an indication of a delta CQI (as described herein). In some examples, the HARQ NACK message may not include an indication of a delta CQI.

In a sixth operation 1030, the network node 110 may transmit, and the UE 120 may receive, second control information (e.g., second scheduling DCI) that schedules a first retransmission of the wireless message that is stored to a second portion of the circular buffer. Additionally, a starting point of the second portion partially overlaps with an end position of the first portion based on a set of characteristics associated with the retransmission, where the various examples of the set of characteristics are provided herein.

In seventh operation 1035, the network node 110 may transmit, and the UE 120 may receive, the first retransmission of the wireless message according to one or more parameters indicated in the second control information (e.g., one or more of resource allocation 405, rank 410, or MCS 415).

In an eighth operation 1040, the UE 120 may determine a starting point in the circular buffer to store the coded bits of the first retransmission using the step-back parameter.

In some examples, the first control information indicates a first explicit MCS and the second control information indicates a second explicit MCS (e.g., example 700). Accordingly, the starting point of the second portion in the circular buffer is a function of the set of characteristics, where the set of characteristics include a nominal number of coded bits included in the wireless message, an RVID indicated for the retransmission, a size of the circular buffer, and the step-back parameter. In some examples, the step-back parameter is indicated in the second control information, in the configuration information, or a combination thereof.

In some examples, the first control information indicates an explicit MCS and the second control information indicates a reserved MCS (e.g., example 800). Accordingly, a starting point of the second portion in the circular buffer is a function of the set of characteristics, where the set of characteristics includes a nominal number of coded bits associated with the wireless message, a size of the circular buffer, a first step-size parameter associated with the retransmission, and a first step-back parameter associated with the retransmission. In some examples, the first step-back parameter is selected from a table that includes a set of step-back parameters respectively associated with a set of modulation order and resource allocation combinations. In some examples, the first step-back parameter is indicated in the second control information.

In a ninth operation 1045, the UE 120 may optionally transmit, and the network node 110 may optionally receive, a HARQ NACK message if the UE 120 is unsuccessful decoding the wireless message after combining the coded bits of the initial transmission with the first retransmission.

In a tenth operation 1050, the network node 110 may optionally transmit third control information (e.g., third scheduling DCI) that schedules a second retransmission of the wireless message that is stored to a second portion of the circular buffer. As shown in FIG. 10, the UE 120 misses (e.g., does not receive) the third control information.

In an eleventh operation 1055, the network node 110 may optionally transmit the second retransmission of the wireless message according to one or more parameters indicated in the second control information (e.g., one or more of resource allocation 405, rank 410, or MCS 415). As shown in FIG. 10, the UE 120 misses (e.g., does not receive) the second retransmission based on not receiving the third control information.

If, however, the UE 120 successfully received the third control information and the second retransmission, then the UE 120 may store the second retransmission to a third portion in the circular buffer. For example, the third portion in the circular buffer may be based on the nominal number of coded bits, the size of the circular buffer, the first step-size parameter, the first step-back parameter, a second step-size parameter associated with the second retransmission, and a second step-back parameter associated with the second retransmission.

In a twelfth operation 1060, the network node 110 may optionally transmit, and the UE 120 may receive, fourth control information (e.g., fourth scheduling DCI) that schedules a third retransmission of the wireless message. In some examples, the UE 120 may identify unsuccessful reception of the third control information that scheduled the second retransmission. The UE 120 may identify missing the third control information and second retransmission based on the RVID value indicated in the fourth control information being two greater than the RVID value indicated in the second control information.

In thirteenth operation 1065, the network node 110 may transmit, and the UE 120 may receive, the third retransmission of the wireless message according to one or more parameters indicated in the fourth control information (e.g., one or more of resource allocation 405, rank 410, or MCS 415).

In a fourteenth operation 1070, the UE 120 may skip over the third portion of the circular buffer (intended for storing the coded bits of the second retransmission) to a fourth portion of the circular buffer to store a third retransmission of the wireless message. In some examples, a size of the third portion that is skipped may be based on a set of parameters indicated in the fourth control information (e.g., using the step-back parameter and the step-size parameter indicated for storing the third retransmission to determine the size of the third portion to skip over). In some examples, a size of the third portion that is skipped may be based on a set of parameters indicated in the first control information or the second control information (e.g., using the step-back parameter and the step-size parameter indicated for storing the first retransmission to determine the size of the third portion to skip over).

In a fifteenth operation 1075, the UE 120 may use the coded bits stored to the circular buffer from the initial transmission and the one or more retransmissions to successfully decode the wireless message. For example, the circular buffer facilitates the combination of systematic bits and parity bits from these transmissions and retransmissions to enhance the likelihood of successful message decoding. Systematic bits are the data bits that are directly encoded by the network node 110, while parity bits are additional bits generated by the encoding process to provide error correction capabilities. The combination of the systematic bits and the parity bits forms a codeword for the wireless message. Accordingly, the initial transmission may include a portion of the systematic bits and a portion of the parity bits from the codeword. Upon receiving retransmissions, the UE 120 stores the incoming coded bits in the circular buffer, which is structured to accommodate overlapping portions of data from successive transmissions (e.g., using the step-back parameter, which dictates how the LSBs of one transmission can partially overlap with the MSBs of the next retransmission). The design of the circular buffer allows the UE 120 to efficiently manage these overlaps, ensuring that all relevant systematic and parity bits are retained for combination. Accordingly, the UE 120 combines the coded bits stored to the buffer by aligning the respective positions of the coded bits in the circular buffer. This alignment process may involve aggregating systematic bits from the initial transmission with parity bits from subsequent retransmissions, effectively enhancing the error correction capability of the combined codeword. The UE 120 may utilize error correction algorithms (such as low-density parity-check (LDPC) decoding), to process the combined bits, leveraging the redundancy provided by the parity bits to correct errors in the systematic bits. By iteratively combining the coded bits from multiple transmissions, the UE 120 increases the probability of accurately reconstructing the data information included in the wireless message.

In a sixteenth operation 1080, the UE 120 may transmit, and the network node 110 may receive, a HARQ ACK message indicating successful decoding of the wireless message. Accordingly, the UE 120 and the network node 110 may determine that the HARQ process for the wireless message was successfully completed.

As indicated above, FIG. 10 is provided as an example. Other examples may differ from what is described with regard to FIG. 10.

FIG. 11 is a diagram illustrating an example process 1100 performed, for example, at a UE or an apparatus of a UE. Example process 1100 is an example where the apparatus or the UE (e.g., UE 120) performs operations associated with overlap-based continuous rate matching.

As shown in FIG. 11, in some aspects, process 1100 may include receiving, from a network node, first control information that schedules an initial transmission of a wireless message that is stored to a first portion of a circular buffer (block 1110). For example, the UE (e.g., using reception component 1302 or communication manager 1306, depicted in FIG. 13) may receive, from a network node, first control information that schedules an initial transmission of a wireless message that is stored to a first portion of a circular buffer, as described above.

As further shown in FIG. 11, in some aspects, process 1100 may include receiving, from the network node, second control information that schedules a retransmission of the wireless message that is stored to a second portion of the circular buffer, where a starting point of the second portion partially overlaps with an end position of the first portion based at least in part on a set of characteristics associated with the retransmission (block 1120). For example, the UE (e.g., using reception component 1302 or communication manager 1306, depicted in FIG. 13) may receive, from the network node, second control information that schedules a retransmission of the wireless message that is stored to a second portion of the circular buffer, where a starting point of the second portion partially overlaps with an end position of the first portion based at least in part on a set of characteristics associated with the retransmission, as described above.

Process 1100 may include additional aspects, such as any single aspect or any combination of aspects described below or in connection with one or more other processes described elsewhere herein.

In a first aspect, a starting point of the first portion in the circular buffer is at a start of the circular buffer based at least in part on the first portion being associated with the initial transmission.

In a second aspect, alone or in combination with the first aspect, the first control information indicates a first explicit MCS and the second control information indicates a second explicit MCS.

In a third aspect, alone or in combination with one or more of the first and second aspects, a starting point of the second portion in the circular buffer is a function of the set of characteristics, the set of characteristics comprising a nominal number of coded bits included in the wireless message, a redundancy value identifier indicated for the retransmission, a size of the circular buffer, and a step-back parameter.

In a fourth aspect, alone or in combination with one or more of the first through third aspects, the step-back parameter is based at least in part on a modulation order associated with the retransmission.

In a fifth aspect, alone or in combination with one or more of the first through fourth aspects, the step-back parameter is based at least in part on a modulation order associated with the retransmission, a TDRA associated with the retransmission, and a FDRA associated with the retransmission.

In a sixth aspect, alone or in combination with one or more of the first through fifth aspects, the step-back parameter is selected from a table that includes a set of step-back parameters respectively associated with a set of modulation order and resource allocation combinations.

In a seventh aspect, alone or in combination with one or more of the first through sixth aspects, the step-back parameter is indicated in the second control information.

In an eighth aspect, alone or in combination with one or more of the first through seventh aspects, the first control information indicates an explicit MCS and the second control information indicates a reserved MCS.

In a ninth aspect, alone or in combination with one or more of the first through eighth aspects, a starting point of the second portion in the circular buffer is a function of the set of characteristics, the set of characteristics comprising a nominal number of coded bits associated with the wireless message, a size of the circular buffer, a first step-size parameter associated with the retransmission, and a first step-back parameter associated with the retransmission.

In a tenth aspect, alone or in combination with one or more of the first through ninth aspects, the retransmission is a first retransmission, third control information schedules a second retransmission of the wireless message after the first retransmission, the second retransmission is stored to a third portion in the circular buffer, and a starting point of the third portion in the circular buffer is based at least in part on the nominal number of coded bits, the size of the circular buffer, the first step-size parameter, the first step-back parameter, a second step-size parameter associated with the second retransmission, and a second step-back parameter associated with the second retransmission.

In an eleventh aspect, alone or in combination with one or more of the first through tenth aspects, the first step-back parameter is selected from a table that includes a set of step-back parameters respectively associated with a set of modulation order and resource allocation combinations.

In a twelfth aspect, alone or in combination with one or more of the first through eleventh aspects, the first step-back parameter is indicated in the second control information.

In a thirteenth aspect, alone or in combination with one or more of the first through twelfth aspects, the retransmission is a first retransmission, and the process 1100 further includes identifying unsuccessful reception of third control information that was to schedule a second retransmission of the wireless message to be stored to a third portion of the circular buffer, and skipping over a third portion of the circular buffer to a fourth portion of the circular buffer to store a third retransmission of the wireless message, where the third retransmission is scheduled by fourth control information.

In a fourteenth aspect, alone or in combination with one or more of the first through thirteenth aspects, a size of the third portion that is skipped is based on a set of parameters indicated in the fourth control information.

In a fifteenth aspect, alone or in combination with one or more of the first through fourteenth aspects, a size of the third portion that is skipped is based on a set of parameters indicated in first control information or the second control information.

In a sixteenth aspect, alone or in combination with one or more of the first through fifteenth aspects, transmission and retransmission of the wireless message is part of a HARQ scheme that employs a reserved MCS for an initial set of retransmissions of the wireless message and an explicit MCS for one or more retransmissions of the wireless message that occur after the initial set of retransmissions.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with overlap-based continuous rate matching.

As shown in FIG. 12, in some aspects, process 1200 may include transmitting, to a UE, first control information that schedules an initial transmission of a wireless message that is stored to a first portion of a circular buffer (block 1210). For example, the network node (e.g., using transmission component 1404 or communication manager 1406, depicted in FIG. 14) may transmit, to a UE, first control information that schedules an initial transmission of a wireless message that is stored to a first portion of a circular buffer, as described above.

As further shown in FIG. 12, in some aspects, process 1200 may include transmitting, to the UE, second control information that schedules a retransmission of the wireless message that is stored to a second portion of the circular buffer, where a starting point of the second portion partially overlaps with an end position of the first portion based at least in part on a set of characteristics associated with the retransmission (block 1220). For example, the network node (e.g., using transmission component 1404 or communication manager 1406, depicted in FIG. 14) may transmit, to the UE, second control information that schedules a retransmission of the wireless message that is stored to a second portion of the circular buffer, where a starting point of the second portion partially overlaps with an end position of the first portion based at least in part on a set of characteristics associated with the retransmission, as described above.

Process 1200 may include additional aspects, such as any single aspect or any combination of aspects described below or in connection with one or more other processes described elsewhere herein.

In a first aspect, a starting point of the first portion in the circular buffer is at a start of the circular buffer based at least in part on the first portion being associated with the initial transmission.

In a second aspect, alone or in combination with the first aspect, the first control information indicates a first explicit MCS and the second control information indicates a second explicit MCS.

In a third aspect, alone or in combination with one or more of the first and second aspects, a starting point of the second portion in the circular buffer is a function of the set of characteristics, the set of characteristics comprising a nominal number of coded bits included in the wireless message, a redundancy value identifier indicated for the retransmission, a size of the circular buffer, and a step-back parameter.

In a fourth aspect, alone or in combination with one or more of the first through third aspects, the step-back parameter is based at least in part on a modulation order associated with the retransmission.

In a fifth aspect, alone or in combination with one or more of the first through fourth aspects, the step-back parameter is based at least in part on a modulation order associated with the retransmission, a TDRA associated with the retransmission, and a FDRA associated with the retransmission.

In a sixth aspect, alone or in combination with one or more of the first through fifth aspects, the step-back parameter is selected from a table that includes a set of step-back parameters respectively associated with a set of modulation order and resource allocation combinations.

In a seventh aspect, alone or in combination with one or more of the first through sixth aspects, the step-back parameter is indicated in the second control information.

In an eighth aspect, alone or in combination with one or more of the first through seventh aspects, the first control information indicates an explicit MCS and the second control information indicates a reserved MCS.

In a ninth aspect, alone or in combination with one or more of the first through eighth aspects, a starting point of the second portion in the circular buffer is a function of the set of characteristics, the set of characteristics comprising a nominal number of coded bits associated with the wireless message, a size of the circular buffer, a first step-size parameter associated with the retransmission, and a first step-back parameter associated with the retransmission.

In a tenth aspect, alone or in combination with one or more of the first through ninth aspects, the retransmission is a first retransmission, third control information schedules a second retransmission of the wireless message after the first retransmission, the second retransmission is stored to a third portion in the circular buffer, and a starting point of the third portion in the circular buffer is based at least in part on the nominal number of coded bits, the size of the circular buffer, the first step-size parameter, the first step-back parameter, a second step-size parameter associated with the second retransmission, and a second step-back parameter associated with the second retransmission.

In an eleventh aspect, alone or in combination with one or more of the first through tenth aspects, the first step-back parameter is selected from a table that includes a set of step-back parameters respectively associated with a set of modulation order and resource allocation combinations.

In a twelfth aspect, alone or in combination with one or more of the first through eleventh aspects, the first step-back parameter is indicated in the second control information.

In a thirteenth aspect, alone or in combination with one or more of the first through twelfth aspects, transmission and retransmission of the wireless message is part of a HARQ scheme that employs a reserved MCS for an initial set of retransmissions of the wireless message and an explicit MCS for one or more retransmissions of the wireless message that occur after the initial set of retransmissions.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 2 through 10. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, from a network node, first control information that schedules an initial transmission of a wireless message that is stored to a first portion of a circular buffer. The reception component 1302 may receive, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 2 through 10. Additionally, or alternatively, the apparatus 1400 may be configured to perform one or more processes described herein, such as process 1200 of FIG. 12. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit, to a UE, first control information that schedules an initial transmission of a wireless message that is stored to a first portion of a circular buffer. The transmission component 1404 may transmit, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network node, first control information that schedules an initial transmission of a wireless message that is stored to a first portion of a circular buffer; and receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

Aspect 2: The method of Aspect 1, wherein a starting point of the first portion in the circular buffer is at a start of the circular buffer based at least in part on the first portion being associated with the initial transmission.

Aspect 3: The method of any of Aspects 1-2, wherein the first control information indicates a first explicit modulation and coding scheme (MCS) and the second control information indicates a second explicit MCS.

Aspect 4: The method of Aspect 3, wherein a starting point of the second portion in the circular buffer is a function of the set of characteristics, the set of characteristics comprising: a nominal number of coded bits included in the wireless message, a redundancy value identifier indicated for the retransmission, a size of the circular buffer, and a step-back parameter.

Aspect 5: The method of Aspect 4, wherein the step-back parameter is based at least in part on a modulation order associated with the retransmission.

Aspect 6: The method of Aspect 4, wherein the step-back parameter is based at least in part on a modulation order associated with the retransmission, a time domain resource allocation (TDRA) associated with the retransmission, and a frequency domain resource allocation (FDRA) associated with the retransmission.

Aspect 7: The method of Aspect 4, wherein the step-back parameter is selected from a table that includes a set of step-back parameters respectively associated with a set of modulation order and resource allocation combinations.

Aspect 8: The method of Aspect 4, wherein the step-back parameter is indicated in the second control information.

Aspect 9: The method of any of Aspects 1-8, wherein the first control information indicates an explicit modulation and coding scheme (MCS) and the second control information indicates a reserved MCS.

Aspect 10: The method of Aspect 9, wherein a starting point of the second portion in the circular buffer is a function of the set of characteristics, the set of characteristics comprising: a nominal number of coded bits associated with the wireless message, a size of the circular buffer, a first step-size parameter associated with the retransmission, and a first step-back parameter associated with the retransmission.

Aspect 11: The method of Aspect 10, wherein the retransmission is a first retransmission, third control information schedules a second retransmission of the wireless message after the first retransmission, the second retransmission is stored to a third portion in the circular buffer, and wherein a starting point of the third portion in the circular buffer is based at least in part on: the nominal number of coded bits, the size of the circular buffer, the first step-size parameter, the first step-back parameter, a second step-size parameter associated with the second retransmission, and a second step-back parameter associated with the second retransmission.

Aspect 12: The method of Aspect 10, wherein the first step-back parameter is selected from a table that includes a set of step-back parameters respectively associated with a set of modulation order and resource allocation combinations.

Aspect 13: The method of Aspect 10, wherein the first step-back parameter is indicated in the second control information.

Aspect 14: The method of Aspect 10, wherein the retransmission is a first retransmission, the method further comprising: identifying unsuccessful reception of third control information that was to schedule a second retransmission of the wireless message to be stored to a third portion of the circular buffer; and skipping over a third portion of the circular buffer to a fourth portion of the circular buffer to store a third retransmission of the wireless message, wherein the third retransmission is scheduled by fourth control information.

Aspect 15: The method of Aspect 14, wherein a size of the third portion that is skipped is based on a set of parameters indicated in the fourth control information.

Aspect 16: The method of Aspect 14, wherein a size of the third portion that is skipped is based on a set of parameters indicated in first control information or the second control information.

Aspect 17: The method of any of Aspects 1-16, wherein transmission and retransmission of the wireless message is part of a hybrid automatic repeat request (HARQ) scheme that employs a reserved modulation and coding scheme (MCS) for an initial set of retransmissions of the wireless message and an explicit MCS for one or more retransmissions of the wireless message that occur after the initial set of retransmissions.

Aspect 18: A method of wireless communication performed by a network node, comprising: transmitting, to a user equipment (UE), first control information that schedules an initial transmission of a wireless message that is stored to a first portion of a circular buffer; and transmitting, to the UE, second control information that schedules a retransmission of the wireless message that is stored to a second portion of the circular buffer, wherein a starting point of the second portion partially overlaps with an end position of the first portion based at least in part on a set of characteristics associated with the retransmission.

Aspect 19: The method of Aspect 18, wherein a starting point of the first portion in the circular buffer is at a start of the circular buffer based at least in part on the first portion being associated with the initial transmission.

Aspect 20: The method of any of Aspects 18-19, wherein the first control information indicates a first explicit modulation and coding scheme (MCS) and the second control information indicates a second explicit MCS.

Aspect 21: The method of Aspect 20, wherein a starting point of the second portion in the circular buffer is a function of the set of characteristics, the set of characteristics comprising: a nominal number of coded bits included in the wireless message, a redundancy value identifier indicated for the retransmission, a size of the circular buffer, and a step-back parameter.

Aspect 22: The method of Aspect 21, wherein the step-back parameter is based at least in part on a modulation order associated with the retransmission.

Aspect 23: The method of Aspect 21, wherein the step-back parameter is based at least in part on a modulation order associated with the retransmission, a time domain resource allocation (TDRA) associated with the retransmission, and a frequency domain resource allocation (FDRA) associated with the retransmission.

Aspect 24: The method of Aspect 21, wherein the step-back parameter is selected from a table that includes a set of step-back parameters respectively associated with a set of modulation order and resource allocation combinations.

Aspect 25: The method of Aspect 21, wherein the step-back parameter is indicated in the second control information.

Aspect 26: The method of any of Aspects 18-25, wherein the first control information indicates an explicit modulation and coding scheme (MCS) and the second control information indicates a reserved MCS.

Aspect 27: The method of Aspect 26, wherein a starting point of the second portion in the circular buffer is a function of the set of characteristics, the set of characteristics comprising: a nominal number of coded bits associated with the wireless message, a size of the circular buffer, a first step-size parameter associated with the retransmission, and a first step-back parameter associated with the retransmission.

Aspect 28: The method of Aspect 27, wherein the retransmission is a first retransmission, third control information schedules a second retransmission of the wireless message after the first retransmission, the second retransmission is stored to a third portion in the circular buffer, and wherein a starting point of the third portion in the circular buffer is based at least in part on: the nominal number of coded bits, the size of the circular buffer, the first step-size parameter, the first step-back parameter, a second step-size parameter associated with the second retransmission, and a second step-back parameter associated with the second retransmission.

Aspect 29: The method of Aspect 27, wherein the first step-back parameter is selected from a table that includes a set of step-back parameters respectively associated with a set of modulation order and resource allocation combinations.

Aspect 30: The method of Aspect 27, wherein the first step-back parameter is indicated in the second control information.

Aspect 31: The method of any of Aspects 18-30, wherein transmission and retransmission of the wireless message is part of a hybrid automatic repeat request (HARQ) scheme that employs a reserved modulation and coding scheme (MCS) for an initial set of retransmissions of the wireless message and an explicit MCS for one or more retransmissions of the wireless message that occur after the initial set of retransmissions.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.

Aspect 33: An apparatus for wireless communication at a device, the apparatus comprising one or more memories and one or more processors coupled to the one or more memories, the one or more processors configured to cause the device to perform the method of one or more of Aspects 1-31.

Aspect 34: An apparatus for wireless communication, the apparatus comprising at least one means for performing the method of one or more of Aspects 1-31.

Aspect 35: A non-transitory computer-readable medium storing code for wireless communication, the code comprising instructions executable by one or more processors to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

Aspect 37: A device for wireless communication, the device comprising a processing system that includes one or more processors and one or more memories coupled with the one or more processors, the processing system configured to cause the device to perform the method of one or more of Aspects 1-31.

Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.

Aspect 39: A device comprising a processing system that includes one or more processors and one or more code-storing memories coupled with the one or more processors, the processing system configured to cause the device to perform the method of one or more of Aspects 1-31.

Aspect 40: A device comprising a processing system that includes processor circuitry and code-storing memory circuitry, the processing system configured to cause the device to perform the method of one or more of Aspects 1-31.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, first control information that schedules an initial transmission of a wireless message that is stored to a first portion of a circular buffer; and
receive, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

2. The UE of claim 1, wherein a starting point of the first portion in the circular buffer is at a start of the circular buffer based at least in part on the first portion being associated with the initial transmission.

3. The UE of claim 1, wherein the first control information indicates a first explicit modulation and coding scheme (MCS) and the second control information indicates a second explicit MCS.

4. The UE of claim 3, wherein a starting point of the second portion in the circular buffer is a function of the set of characteristics, the set of characteristics comprising:
a nominal number of coded bits included in the wireless message,
a redundancy value identifier indicated for the retransmission,
a size of the circular buffer, and
a step-back parameter.

5. The UE of claim 4, wherein the step-back parameter is based at least in part on a modulation order associated with the retransmission.

6. The UE of claim 4, wherein the step-back parameter is based at least in part on a modulation order associated with the retransmission, a time domain resource allocation (TDRA) associated with the retransmission, and a frequency domain resource allocation (FDRA) associated with the retransmission.

7. The UE of claim 4, wherein the step-back parameter is selected from a table that includes a set of step-back parameters respectively associated with a set of modulation order and resource allocation combinations.

8. The UE of claim 4, wherein the step-back parameter is indicated in the second control information.

9. The UE of claim 1, wherein the first control information indicates an explicit modulation and coding scheme (MCS) and the second control information indicates a reserved MCS.

10. The UE of claim 9, wherein a starting point of the second portion in the circular buffer is a function of the set of characteristics, the set of characteristics comprising:
a nominal number of coded bits associated with the wireless message,
a size of the circular buffer,
a first step-size parameter associated with the retransmission, and
a first step-back parameter associated with the retransmission.

11. The UE of claim 10, wherein the retransmission is a first retransmission, third control information schedules a second retransmission of the wireless message after the first retransmission, the second retransmission is stored to a third portion in the circular buffer, and wherein a starting point of the third portion in the circular buffer is based at least in part on:
the nominal number of coded bits,
the size of the circular buffer,
the first step-size parameter,
the first step-back parameter,
a second step-size parameter associated with the second retransmission, and
a second step-back parameter associated with the second retransmission.

12. The UE of claim 10, wherein the first step-back parameter is selected from a table that includes a set of step-back parameters respectively associated with a set of modulation order and resource allocation combinations.

13. The UE of claim 10, wherein the first step-back parameter is indicated in the second control information.

14. The UE of claim 10, wherein the retransmission is a first retransmission, the processing system further configured to cause the UE to:
identify unsuccessful reception of third control information that was to schedule a second retransmission of the wireless message to be stored to a third portion of the circular buffer; and
skip over a third portion of the circular buffer to a fourth portion of the circular buffer to store a third retransmission of the wireless message, wherein the third retransmission is scheduled by fourth control information.

15. The UE of claim 14, wherein a size of the third portion that is skipped is based on a set of parameters indicated in the fourth control information.

16. The UE of claim 14, wherein a size of the third portion that is skipped is based on a set of parameters indicated in first control information or the second control information.

17. The UE of claim 1, wherein transmission and retransmission of the wireless message is part of a hybrid automatic repeat request (HARQ) scheme that employs a reserved modulation and coding scheme (MCS) for an initial set of retransmissions of the wireless message and an explicit MCS for one or more retransmissions of the wireless message that occur after the initial set of retransmissions.

18. A method of wireless communication performed by a user equipment (UE), comprising:
receiving, from a network node, first control information that schedules an initial transmission of a wireless message that is stored to a first portion of a circular buffer; and
receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.

19. The method of claim 18, wherein a starting point of the first portion in the circular buffer is at a start of the circular buffer based at least in part on the first portion being associated with the initial transmission.

20. An apparatus for wireless communication, comprising:
means for receiving, from a network node, first control information that schedules an initial transmission of a wireless message that is stored to a first portion of a circular buffer; and
means for receiving, from the network node, second control information that schedules a retransmission of the wireless message that is stored to a second portion of the circular buffer, wherein a starting point of the second portion partially overlaps with an end position of the first portion based at least in part on a set of characteristics associated with the retransmission.
